(19) United States
(12) Patent Application Publication
(10) Pub. No.: US 2008/0022940 A1
(43) Pub. Date: Jan. 31, 2008

(54) Composite Absorbent Particles with Superabsorbent Material

(76) Inventors: Bradley Kirsch, Pleasanton, CA (US); Charles Fritter, Pleasanton, CA (US); Dennis Jenkins, Pleasanton, CA (US); Marc Privitera, Walnut Creek, CA (US); David Lestage, Livermore, CA (US); David Strack, Pleasanton, CA (US)

Correspondence Address: THE CLOROX COMPANY, P.O. BOX 24305, OAKLAND, CA, 94623-1305, US

(21) Appl. No.: 11/871,778

(22) Filed: Oct. 12, 2007

Related U.S. Application Data
(63) Continuation-in-part of application No. 10/618,401, filed on Jul. 11, 2003.
(60) Provisional application No. 60/863,894, filed on Nov. 1, 2006.

(51) Int. Cl. A01K 29/00

(52) U.S. Cl. 119/173; 119/171

(57) ABSTRACT

Composite particles suitable for use as a clumping animal litter according to one embodiment include an absorbent material, and a superabsorbent polymer coupled to the absorbent material, where a ratio of rates of absorption of the superabsorbent polymer and absorbent material is at least about 1:1. Composite particles suitable for use as a clumping animal litter according to another embodiment include an absorbent material and a superabsorbent polymer coupled to the absorbent material, where the superabsorbent polymer has a greater Jenkins osmotic potential than the absorbent material.

### CROSS REFERENCES TO RELATED APPLICATIONS

This application is a continuation-in-part of application Ser. No. 10/618,401, filed Jul. 11, 2003, which is hereby incorporated by reference in its entirety. This application claims the benefit of U.S. Provisional Application No. 60/863,894, filed Nov. 1, 2006, which is hereby incorporated by reference in its entirety.

### FIELD OF THE INVENTION

The present invention relates to composite absorbent particles, and more particularly, this invention relates to a composite absorbent particle having improved clumping and/or liquid-retaining properties.

### BACKGROUND OF THE INVENTION

Clay has long been used as a liquid absorbent, and has found particular usefulness as an animal litter.

Because of the growing number of domestic animals used as house pets, there is a need for litters so that animals may micturate, void or otherwise eliminate liquid or solid waste indoors in a controlled location. Many cat litters use clay as an absorbent. Typically, the clay is mined, dried, and crushed to the desired particle size.

Some clay litters have the ability to clump upon wetting. For example, sodium bentonite is a water-swellable clay which, upon contact with moist animal waste, is able to agglomerate with other moistened sodium bentonite clay particles. The moist animal waste is contained by the agglomeration of the moist clay particles into an isolatable clump, which can be removed from the container (e.g., litterbox) housing the litter. However, the clump strength of clay litters described above is typically not strong enough to hold the clump shape upon scooping, and inevitably, pieces of the litter break off of the clump and remain in the litter box, allowing waste therein to form malodors. The breakage problem is compounded when the size of the clump is large.

Further, raw clay typically has a high clump aspect ratio when urinated in. The result is that the wetted portion of clay will often extend to the container containing it and stick to the side or bottom of the container. This in turn often results in wetted litter remaining in the container after removal of the clump. The wetted litter that remains is often a source of strong malodors, and is also often difficult to remove from the container once dried. High clump aspect ratios also require removal of large quantities of soiled litter from the container.

Another problem inherent in typical litters is the inability to effectively control malodors. Clay has very poor odor-controlling qualities, and inevitably waste build-up leads to severe malodor production. One attempted solution to the malodor problem has been the introduction of granular activated carbon (GAC) into the litter. However, the GAC is usually dry blended with the litter, making the litter undesirably dusty. Also, the GAC concentration must typically be 1% by weight or higher to be effective. Activated carbon is very expensive, and the need for such high concentrations greatly increases production costs. Further, because the clay and GAC particles are merely mixed, the litter will have GAC concentrated in some areas, and particles with no GAC in other areas.

The human objection to odor is not the only reason that it is desirable to reduce odors. Studies have shown that cats are territorial animals and will often “mark” litter that has little or no smell with their personal odor, such as by urinating. When cats return to the litterbox and don't sense their odor, they will try to mark their territory again. The net effect is that cats will return to use a litter box more often if the odor of their markings are reduced. Thus, a litter that is effective at eliminating or hiding a cat's personal odor can encourage the animal to use a litter box rather than depositing waste outside the box.

What is needed is an absorbent article of manufacture that is suitable for use as a cat litter/liquid absorbent with at least one of the following properties: better clumping characteristics, e.g., aspect ratio and/or clump strength, than absorbent materials heretofore known; improved odor-controlling properties, and that maintains such properties for longer periods of time and/or requiring much lower concentrations of odor controlling actives; a lower bulk density while maintaining a high absorbency rate comparable to or exceeding heretofore known materials; and which encourages animals to micturate and void on the absorbent material.

What is also needed are ways to form these and other types of particles.

### SUMMARY OF THE INVENTION

Composite particles suitable for use as a clumping animal litter according to one embodiment include an absorbent material, and a superabsorbent polymer coupled to the absorbent material, where a ratio of rates of absorption of the superabsorbent polymer and absorbent material is at least about 1:1.

The absorbent material may be a liquid-absorbing material and may be selected from a group consisting of: a mineral, fly ash, absorbing pelletized material, perlite, silica, organic materials, and mixtures thereof.

Preferably, the composite particles tend to clump together in the presence of a liquid, as they would where the absorbent material is sodium bentonite clay.

A performance-enhancing active may be added to the particles. Illustrative additives include an antimicrobial, an odor reducing material, a binder, a fragrance, a health indicating material, a color altering agent, a dust reducing agent, a nonstick release agent, a superabsorbent material, cyclodextrin, zeolite, activated carbon, a pH altering agent, a salt forming material, a ricinoleate, silica gel, crystalline silica, activated alumina, a clump enhancing agent, and mixtures thereof. One illustrative additive is a boron-containing compound present in an antimicrobially effective amount, such as borax pentahydrate, borax decahydrate, boric acid, polyborate, tetraboric acid, sodium metaborate, anhydrous, boron components of polymers, and mixtures thereof. Further additives include a humectant, desiccant, and deliquescent, which may be coupled to the superabsorbent polymer.

Preferably, a clump of the particles is at least 90% retained according to a clump strength test. Also preferably, the superabsorbent polymer has a greater Jenkins osmotic potential than the absorbent material.

An average particle size of the superabsorbent polymer is preferably smaller than an average particle size of the absorbent material.

The superabsorbent polymer may be homogeneously mixed with the absorbent material, bound to an outer surface of the composite particles, formed or found in one or more layers of the particle, physically dispersed in pockets in the particle, within pores of the particle, etc.

At least some of the composite particles may include a core, the absorbent material being coupled to the core. At least some of the composite particles may be hollow. At least some of the composite particles naturally form a general bagel shape.

Composite particles suitable for use as a clumping animal litter according to another embodiment include an absorbent material and a superabsorbent polymer coupled to the absorbent material, where the superabsorbent polymer has a greater Jenkins osmotic potential than the absorbent material.

The composite particles described above may be formed by an agglomeration process.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 illustrates several configurations of absorbent composite particles according to various embodiments of the present invention.

FIG. 2A is a plot of bulk density reduction vs. fiber content in an absorbent particle.

FIG. 2B is a photograph of composite particles containing sodium bentonite and 15% paper fluff fibers

FIG. 3A is a cross sectional view of a hollow SAP particle.

FIG. 3B is a cross sectional view of an SAP-containing particle with a permeable skin surrounding an SAP core.

FIG. 3C is a cross sectional view of an SAP-containing particle with a fast absorbing layer surrounding an SAP core.

FIG. 3D is a cross sectional view of an absorbent particle according to one embodiment.

FIGS. 3E-H illustrate the progression of the formation of pores in a structure of absorbent material, structure directing agent and solvent.

FIG. 4A is a process diagram illustrating a pan agglomeration process according to a preferred embodiment.

FIG. 4B depicts the structure of an illustrative agglomerated composite particle formed by the process of FIG. 2.

FIG. 4C is a process diagram illustrating another exemplary pan agglomeration process with a recycle subsystem.

FIG. 5 is a process diagram illustrating an exemplary pin mixer process for forming composite absorbent particles.

FIG. 6 is a process diagram illustrating an exemplary mix muller process for forming composite absorbent particles.

FIG. 7 is a process diagram illustrating recovery of raw material from a first process and use thereof in a second process.

FIG. 8 is a flow diagram depicting a general method for dry bed agglomeration according to one embodiment of the present invention.

FIG. 9 is a process diagram of an illustrative system for creating composite particles by dry bed agglomeration.

FIG. 10 illustrates perspective views of several potential shapes for absorbent particles.

FIG. 12 is a process diagram illustrating a method of using absorbent particles.

FIG. 13 is a process diagram illustrating a method for orienting particles.

FIG. 13 depicts the clumping action of composite absorbent particles according to a preferred embodiment.

FIG. 14 depicts disintegration of a composite absorbent particle according to a preferred embodiment.

FIG. 15 is a graph depicting malodor ratings.

FIG. 16 is an interval plot of mass transferred (g) to the dropped filter paper vs. sample (surface stickiness) for experimental results.

FIG. 17 is an interval plot of clump mass (g) vs. sample for experimental results.

FIG. 18 is an interval plot of clump depth (cm) vs. sample for experimental results.

FIG. 19 is an interval plot of liquid absorption (g/g) vs. sample for experimental results.

### BEST MODES FOR CARRYING OUT THE INVENTION

The following description includes the best embodiments presently contemplated for carrying out the present invention. This description is made for the purpose of illustrating the general principles of the present invention and is not meant to limit the inventive concepts claimed herein.

The present invention relates generally to composite absorbent particles with improved physical and chemical properties comprising an absorbent material and optional performance-enhancing actives. By using various processes described herein, such particles can be “engineered” to preferentially exhibit specific characteristics including but not limited to improved odor control, lower density, easier scooping, better particle/active consistency, higher clump strength, etc. One of the many benefits of this technology is that the performance-enhancing actives may be positioned to optimally react with target molecules such as but not limited to odor causing volatile substances, resulting in surprising odor control with very low levels of active ingredient.

A preferred use for the absorbent particles is as a cat litter, and therefore much of the discussion herein will refer to cat litter applications. However, it should be kept in mind that the absorbent particles have a multitude of applications, such as air and water filtration, fertilizer, waste remediation, etc., and should not be limited to the context of a cat litter.

One preferred method of forming the absorbent particles is by agglomerating granules of an absorbent material in a pan agglomerator. A preferred pan agglomeration process is set forth in more detail below, but is described generally here to aid the reader. Generally, the granules of absorbent material are added to an angled, rotating pan. A fluid or binder is added to the granules in the pan to cause binding of the granules. As the pan rotates, the granules combine or agglomerate to form particles. Depending on pan angle and pan speed among other factors, the particles tumble out of the agglomerator when they reach a certain size. The particles are then dried and collected.

One or more performance-enhancing actives are preferably added to the particles in an amount effective to perform the desired functionality or provide the desired benefit. For example, these actives can be added during the agglomeration process so that the actives are incorporated into the particle itself, or can be added during a later processing step.

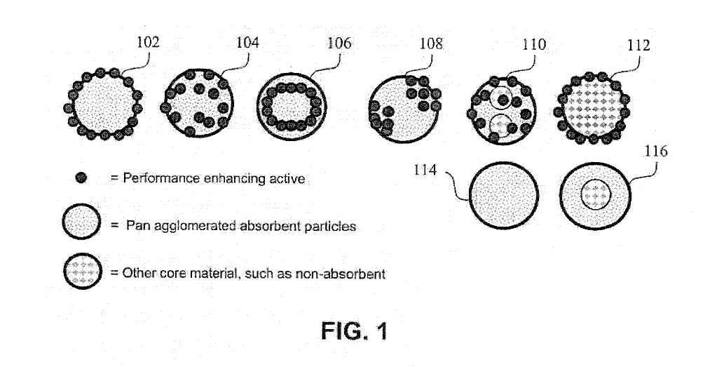

FIG. 1 shows several embodiments of the absorbent particles of the present invention. These particles have actives incorporated:
1. In a layer on the surface of a particle (102)
2. Evenly (homogeneously) throughout a composite litter particle (104)
3. In a concentric layer(s) throughout the particle and/or around a core (106)
4. In pockets or pores in and/or around a particle (108)
5. In a particle with single or multiple cores (110)
6. Utilizing non-absorbent cores (112)
7. No actives (114)
8. No actives, but with single or multiple cores (116)
9. In any combination of the above

As previously recited hereinabove, other particle-forming processes may be used to form the inventive particles of the present invention. For example, without limitation, extrusion and fluid bed processes appear appropriate. Extrusion process typically involves introducing a solid and a liquid to form a paste or doughy mass, then forcing through a die plate or other sizing means. Because the forcing of a mass through a die can adiabatically produce heat, a cooling jacket or other means of temperature regulation may be necessary. The chemical engineering literature has many examples of extrusion techniques, equipment and materials, such as “Outline of Particle Technology,” pp. 1-6 (1999), “Know-How in Extrusion of Plastics (Clays) or NonPlastics (Ceramic Oxides) Raw Materials, pp. 1-2, “Putting Crossflow Filtration to the Test,” Chemical Engineering, pp. 1-5 (2002), and Brodbeck et al., U.S. Pat. No. 5,269,962, especially col. 18, lines 30-61 thereof, all of which is incorporated herein by reference thereto. Fluid bed process is depicted in Coyne et al., U.S. Pat. No. 5,093,021, especially col. 8, line 65 to col. 9, line 40, incorporated herein by reference.

Materials

Many liquid-absorbing materials may be used without departing from the spirit and scope of the present invention. Illustrative absorbent materials include but are not limited to minerals, fly ash, absorbing pelletized materials, perlite, silicas, other absorbent materials and mixtures thereof. Preferred minerals include: bentonites, zeolites, fullers earth, attapulgite, montmorillonite diatomaceous earth, opaline silica, crystalline silica, silica gel, alumina, Georgia White clay, sepiolite, calcite, dolomite, slate, pumice, tobermite, marls, attapulgite, kaolinite, halloysite, smectite, vermiculite, hectorite, Fuller's earth, fossilized plant materials, expanded perlites, gypsum and other similar minerals and mixtures thereof. One preferred absorbent material is sodium bentonite having a mean particle diameter of about 5000 microns or less, preferably about 3000 microns or less, and ideally in the range of about 25 to about 150 microns.

Because minerals, and particularly clay, are heavy, it may be desirable to reduce the weight of the composite absorbent particles to reduce shipping costs, reduce the amount of material needed to need to fill the same relative volume of the litter box, and to make the material easier for customers to carry. To lower the weight of each particle, a lightweight core material, or “core,” may be incorporated into each particle. The core can be positioned towards the center of the particle with a layer or layers of absorbent and/or active surrounding the core in the form of a shell. This configuration increases the active concentration towards the outside of the particles, making the active more effective. The shell can be of any desirable thickness. In one embodiment with a thin shell, the shell has an average thickness of less than about ½ that of the average diameter of the particle, and preferably the shell has an average thickness of not less than about 1/16 that of the average diameter of the particle. More preferably, the shell has an average thickness of between about 7/16 and ⅛ that of the average diameter of the particle, even more preferably less than about ½ that of the average diameter of the particle, and ideally between about ⅜ and ⅛ that of the average diameter of the particle. Note that these ranges are preferred but not limiting.

According to another embodiment comprising a core and absorbent material surrounding the core in the form of a shell, an average thickness of the shell is at least about four times an average diameter of the core. In another embodiment, an average thickness of the shell is between about 1 and about 4 times an average diameter of the core. In yet another embodiment, an average thickness of the shell is less than an average diameter of the core. In a further embodiment, an average thickness of the shell is less than about one-half an average diameter of the core.

Other ranges can be used, but the thickness of the shell of absorbent material/active surrounding a non-clumping core should be balanced to ensure that good clumping properties are maintained.

In another embodiment, the absorbent material “surrounds” a core (e.g., powder, granules, clumps, etc.) that is dispersed homogeneously throughout the particle or in concentric layers. For example, a lightweight or heavyweight core material can be agglomerated homogeneously into the particle in the same way as the active. The core can be solid, hollow, absorbent, nonabsorbent, and combinations of these.

Exemplary lightweight core materials include but are not limited to calcium bentonite clay, Attapulgite clay, Perlite, Silica, non-absorbent silicious materials, sand, plant seeds, glass, polymeric materials, and mixtures thereof. A preferred material is a calcium bentonite-containing clay which can weigh about half as much as bentonite clay. Calcium bentonite clay is non-clumping so it doesn't stick together in the presence of water, but rather acts as a seed or core. Granules of absorbent material and active stick to these seed particles during the agglomeration process, forming a shell around the seed.

Using the above lightweight materials, a bulk density reduction of ≧10%, ≧20%, preferably ≧30%, more preferably ≧40%, and ideally ≧50% can be achieved relative to generally solid particles of the absorbent material (e.g., as mined) and/or particles without the core material(s). For example, in a particle in which sodium bentonite is the absorbent material, using about 50% of lightweight core of calcium bentonite clay results in about a 42% bulk density reduction.

Heavyweight cores may be used when it is desirable to have heavier particles. Heavy particles may be useful, for example, when the particles are used in an outdoor application in which high winds could blow the particles away from the target zone. Heavier particles also produce an animal litter that is less likely to be tracked out of a litter box. Illustrative heavyweight core materials include but are not limited to sand, iron filings, etc.

Note that the bulk density of the particles can also be adjusted (without use of core material) by manipulating the agglomeration process to increase or decrease pore size, pore volume and surface area of the particle.

Note that active may be added to the core material if desired. Further, the core can be selected to make the litter flushable. One such core material is wood pulp.

In some embodiments, the absorbent materials or composite particles containing absorbent materials may be blended with litter filler materials or other additives suitable for use in animal litter. As used herein the term “litter filler materials” refers to materials that can be used as the absorbent material, but are generally ineffective at liquid absorption if used alone. Therefore these materials are generally used in combination with other absorbent materials to reduce the cost of the final litter product. Illustrative examples of filler materials include limestone, sand, calcite, dolomite, recycled waste materials, zeolites, and gypsum.

Illustrative materials for the performance-enhancing active(s) include but are not limited to antimicrobials, odor absorbers/inhibitors, binders, fragrances, health indicating materials, nonstick release agents, superabsorbent materials, and mixtures thereof. In some embodiments reinforcing fiber materials can be added. Absorbent fibers may be added to some embodiments. One great advantage of the particles of the present invention is that substantially every absorbent particle may contain an active.

Preferred antimicrobial actives are boron containing compounds such as borax pentahydrate, borax decahydrate, boric acid, polyborate, tetraboric acid, sodium metaborate, anhydrous, boron components of polymers, and mixtures thereof.

One type of odor absorbing/inhibiting active inhibits the formation of odors. An illustrative material is a water soluble metal salt such as silver, copper, zinc, iron, and aluminum salts and mixtures thereof. Preferred metallic salts are zinc chloride, zinc gluconate, zinc lactate, zinc maleate, zinc salicylate, zinc sulfate, zinc ricinoleate, copper chloride, copper gluconate, and mixtures thereof. Other odor control actives include nanoparticles that may be composed of many different materials such as carbon, metals, metal halides or oxides, or other materials. Additional types of odor absorbing/inhibiting actives include cyclodextrin, zeolites, silicas, activated carbon (also known as activated charcoal), acidic, salt-forming materials, and mixtures thereof. Activated alumina (Al₂O₃) has been found to provide odor control comparable and even superior to other odor control additives such as activated carbon, zeolites, and silica gel. Alumina is a white granular material, and is properly called aluminum oxide.

The preferred odor absorbing/inhibiting active is Powdered Activated Carbon (PAC), though Granular Activated Carbon (GAC) can also be used. PAC gives much greater surface area than GAC (GAC is something larger than powder (e.g., ≧80 mesh U.S. Standard Sieve (U.S.S.S.))), and thus has more sites with which to trap odor-causing materials and is therefore more effective. PAC has only rarely been used in absorbent particles, and particularly animal litter, as it tends to segregate out of the litter during shipping, thereby creating excessive dust (also known as “sifting”). By agglomerating PAC into particles, the present invention overcomes the problems with carbon settling out during shipping. Generally, the preferred mean particle diameter of the carbon particles used is less than about 500 microns, but can be larger. The particle size can also be much smaller (less than 100 nanometers) as in the case of carbon nanoparticles. The preferred particle size of the PAC is about 150 microns (˜100 mesh U.S.S.S.) or less, and ideally in the range of about 25 to 150 microns, with a mean diameter of about 50 microns (˜325 mesh U.S.S.S.) or less.

An active may be added to reduce or even prevent sticking of the litter to the litter box. Useful anti-stick agents include, but are not limited to, hydrophobic materials such as activated carbon, carbon black, Teflon®, hydrophobic polymers and co-polymers, for example poly(propylene oxide). Other nonstick additives may include surfactants, polymers, polytetrafluoroethylene, starches, silicones, Georgia white clay, sand, limestone. Generally, any mineral material that does not dissolve or swell in the presence of water will act as an inert spacer between the sodium bentonite clay and the litter box, providing some reduction in sticking. The effect is greater when the spacer is a particle size that is finer than the clay.

How tightly swelled litter sticks to a litter box can be measured as a function of the force necessary to remove the ‘clump’. One method of measuring this force uses 150 cc of litter and 20 cc of pooled cat urine (from several cats so it is not specific) to form a clump on the bottom of a cat box. The urine causes the litter to clump, and in so doing, the swelled litter adheres to the litter box. The relative amount of force (in pounds) necessary to remove the adhered clump is measured using an Instron tensile tester and a modified scooper.

The data in the table below refer to the following formulas. Formula P is composed of composite particles of the present invention that contain 0.5% PAC as an anti-stick agent. Formula S is a commercially available granular clay litter with no added anti-stick agents.

The data in the table below show that a urine clump formed from the formula composed of composite particles containing 0.5% PAC as an anti-stick agent requires less force for removal from the bottom of a cat box than a urine clump formed from a commercially available granular clay litter containing no anti-stick agents.

TABLE 1

| Litter height | Formula P - Removal | Formula S - Removal |
|---|---|---|
| (Inches) | Force in pounds | Force in pounds |
| 0.5 | 0.17 | 0.63 |
| 0.25 | 0.46 | 0.81 |

Generally, PAC is effective to reduce sticking when present in the composite particles in an amount of 0.1% or more, preferably in the range of about 0.1 to about 1.0%, when compared to composite particles not having the PAC present.

The active may also include a binder such as water, lignin sulfonate (solid), polymeric binders, fibrillated Teflon® (polytetrafluoroethylene or PTFE), and combinations thereof. Useful organic polymerizable binders include, but are not limited to, carboxymethylcellulose (CMC) and its derivatives and its metal salts, guar gum cellulose, xanthan gum, starch, lignin, polyvinyl alcohol, polyacrylic acid, styrene butadiene resins (SBR), and polystyrene acrylic acid resins. Water stable particles can also be made with crosslinked polyester network, including but not limited to those resulting from the reactions of polyacrylic acid or citric acid with different polyols such as glycerin, polyvinyl alcohol, lignin, and hydroxyethylcellulose.

Another active that can be added to the composite particles is a clump enhancing agent that is activated by contact with a liquid to strengthen clumps, thereby assisting in the isolation and encapsulation of the offensive material. Clump enhancing agents are particularly useful when the composite particles are formed of materials that do not have strong inherent clumping capabilities, and where other non-clumping performance enhancing actives are formed on an outer surface of the particles. Preferred clump enhancing agents include binders, gums, starches, and adhesive polymers. The clump enhancing agent is preferably added to outer surfaces of the particles by spraying or by addition during the final stages of agglomeration. Clump enhancing agents can also be bulk-added to the composite particles.

Dedusting agents can also be added to the particles in order to reduce the dust level in the final product. All of the clump enhancing agents listed above are effective dedusting agents when applied to the outer surface of the composite absorbent particles. Other dedusting agents include but are not limited to fibrillated Teflon, resins, water, and other liquid or liquefiable materials.

A color altering agent such as a dye, pigmented polymer, metallic paint, bleach, lightener, etc. may be added to vary the color of absorbent particles, such as to darken or lighten the color of all or parts of the litter so it is more appealing. Preferably, the color altering agent comprises up to approximately 20% of the absorbent composition, more preferably, 0.001%-5% of the composition. Even more preferably, the color altering agent comprises approximately 0.001%-0.1% of the composition.

Preferred carriers for the color altering agent are zeolites, carbon, charcoal, etc. These substrates can be dyed, painted, coated with powdered colorant, etc.

Activated alumina and activated carbon may include an embedded coloring agent that has been added during the fabrication of the activated alumina or activated carbon particles to form a colored speckle. The inventors have found that the odor absorbing properties of activated alumina and activated carbon are not significantly reduced due to the application of color altering agents thereto.

The color altering agent can be the absorbent material, e.g., a bentonite clay, particularly if the absorbent material contains some dust-sized particles. It has been observed that dust-sized particles actually coat the activated carbon thereby lightening the black color.

Additionally, activated alumina's natural white coloring makes it a desirable choice as a white, painted or dyed “speckle” in litters. In composite and other particles, the activated alumina can also be added in an amount sufficient to lighten or otherwise alter the overall color of the particle or the overall color of the entire composition.

Compositions may also contain colored speckles for visual appeal. Other examples of speckle material are salt crystals or gypsum crystals.

Large particles of carbon, e.g., activated carbon or charcoal, can also be used as a dark speckle. Such particles are preferably within a particle diameter size range of about 0.01 to 10 times the mean diameter of the other particles in the mixture.

Carbon-coated particles of absorbent material (particularly absorbent materials coated with PAC) can also be used as dark speckles. In this case, the particle size of the dark speckles would be virtually the same as uncoated particles of absorbent particles.

Reinforcing Fiber Materials

Reinforcing fiber material(s) (hereinafter “fiber(s)”) may be added to increase clump strength and/or reduce the overall bulk density of the litter material. Fibers are any solid material having a mean cylindrical shape and a length to diameter aspect ratio greater than one that helps to maintain the structural integrity of litter clumps once formed. The fibers may range in particle size from about 1 nm to about 5 mm. The fibers are typically in the size range of about 1 nm to about 5 mm prior to agglomeration, but could be up to 6 inches depending on whether the process used first breaks down the material into a smaller size prior to forming composite particles. The fibers may comprise between 0.1 and 50% of the composite particle, but typically are present in an amount less than 20% (i.e., 19% or less).

Preferred fibers include any solid material that demonstrates a mean cylindrical shape with a large length to diameter aspect ratio (e.g, 2 to 1 or greater) and the following two properties. First, a built tensile strength that is due to molecular orientation induced by the formation of the fiber whether natural or synthetically produced. Second, a surface morphology that creates bonding sites that allow the fiber to reinforce the overall structure of the particle. The bonding sites may be created either by allowing association with other chemical elements and structures (e.g., hydrogen bonding as present in polyester) or by a physical interlocking of surface morphologies (e.g., puzzle pieces).

Fibers may be made of materials such as, but not limited to natural materials, e.g., wool, cotton, hemp, rayon, lyocell, paper, paper fluff, cellulose, regenerated cellulose, bird feathers, carbon, activated carbon, as well as synthetic materials, e.g., polyester, nylon, plastics, polymers (including super absorbent polymers (SAPs) and copolymers). Combinations of these materials are also possible, as in the multi-component fibers discussed below. Illustrative reinforcing fibers include paper fluff, DuPont's Kevlar® (poly-paraphenylene terephthalamide) yarn, PET (polyethylene terephthalate), Tencel® cellulose fiber, rayon, cotton, poultry feather parts, cellulose, and combinations thereof. Reclaim, i.e., a recycled mixture incorporating some or all of the synthetic materials listed above, could also be used.

In addition, fibers recovered as a byproduct or waste product from another process can also be incorporated in the absorbent particles. For example, the fibrous waste from a paper or tissue manufacturing process can be used. The size of the fibers is not critical, and can range from small particles captured by a dust collection process to relatively larger particles.

Other performance-enhancing actives may be embedded within the fibers or attached to the surface of the fibers to augment a specific consumer-benefiting feature, such as odor control or enhanced absorptivity or both. Cotton fibers embedded with activated carbon could be combined with an absorbent clay to form composite particles suitable for use as an animal litter having increased odor control. Non-woven fibers charged with SAPs (e.g., BASF luquafleece IS) can be combined with an absorbent clay to form composite particles having increased absorptivity. The resulting litter compositions have the advantage of controlling odors and moisture as strong clumps are formed.

Benefits imparted by the fibers (either alone or in combination with other performance-enhancing actives) may include without limitation, increased structural integrity (e.g., less breakage and dust), increased clump strength, increased liquid absorption, abrasion resistance, animal attractant/repellant, visual aesthetics, tactile aesthetics, lower overall bulk weight, and increased odor control (e.g., activated carbon fibers). Clump strength is a measure of the mechanisms that aid in the formation of agglomerates (moist litter particles that stick together) in the litter box. Crimped fibers (helical and saw-tooth) may provide higher clumping strength or reduced attrition in processing and handling.

Bicomponent and/or multi-component fibers may provide additional benefits. For example, one component of the fiber may melt and act as an adhesive during the agglomeration drying process to further enhance the strength of the composite particles, while the other component may retain its length/integrity in order to provide a reinforcing benefit and increase clump strength. When the fiber is subjected to the melt temp of the lower meting component, the lower melting component acts as the adhesive, while the higher melting component retains the shape and a portion of the integrity of the fiber. Some examples include fibers made of both polyethylene and polyester, or polyethylene and polypropylene in a side by side or a sheath /core configuration.

Additional attributes may be present if the fibers are porous. Fiber porosity could lead to a three-fold benefit: (1) light-weighting (i.e., a decrease in the bulk density of the litter composition), (2) increased odor and/or moisture absorption (i.e., within the pores due to an increase in surface area), and (3) encapsulation/carrier vehicle for performance-enhancing actives, such as odor absorbers, moisture absorbers, antimicrobials, fragrances, clumping agents, etc. These benefits combined with the aforementioned additional clump strength and clump integrity are unexpected. Generally lower density, higher porosity litter materials with litter additives work to decrease clump strength. This common drawback is overcome by the composite particles disclosed herein.

When only 2% paper fluff fibers are added to a primarily sodium bentonite composition via a pilot plant scale pin mixer equipped with a rotary drier, a 13% reduction in bulk density is observed.

The clump aspect ratio, which is defined as Square root ((longest clump length)2+(shortest clump length) 2)/clump height may be affected by the addition of fibers to the composite particles. In general, it is desirable to have a round clump, which translates to an aspect ratio of about 0.5. Higher aspect ratios are indicative of less round, more “pancake-shaped” clumps, which may be acceptable, if other benefits are gained (e.g., an increase in liquid absorption or a decrease in clumps sticking to the box).

The fibers can range in particle size from about 1 nm to about 6 inches (typically ranging between 1 nm and 5 mm) and generally are present in 0.1-50% by weight of the composite particles. The size and shape of the fibers chosen may aid in controlling the particle size and shape of the resulting composite particles. For example, it is expected that longer fibers will yield larger agglomerate particles and a blend of fiber lengths will yield composite particles of varying particle sizes.

U.S. Pat. No. 5,705,030 assigned to the United States Department of Agriculture, which is hereby incorporated by reference in its entirety, describes a process for converting chicken feathers into fibers. According to U.S. Pat. No. 5,705,030, feathers from all avian sources have the characteristics which are necessary for the production of useful fibers, therefore feathers from any avian species may be utilized. Feathers are made up of many slender, closely arranged parallel barbs forming a vane on either side of a tapering hollow shaft. The barbs have bare barbules which in turn bare barbicels commonly ending in hooked hamuli and interlocking with the barbules of an adjacent barb to link the barbs into a continuous vane.

Structurally, chicken feather fibers have naturally-occurring nodes approximately 50 microns apart. These nodes are potential cleavage sites for producing fibers of uniform 40-50 μm lengths. In addition, feathers from different species vary in length: poultry feather fibers are approximately 2 cm in length while those derived from exotic birds such as peacocks or ostriches are 4 to 5 cm or longer. Feather fibers are also thinner than other natural fibers resulting in products having a smooth, fine surface.

The composition of wood pulp fiber is generally about 50% cellulose with the remainder being lignin and hemicelluloses. Hardwood trees have broad leaves and softwood trees have needle-like or scale-like leaves. Hardwood trees have shorter fibers compared to softwood trees. All freshly cut wood contains moisture. Wood pulp has a tendency to be at “equilibrium density”, i.e., the density at which the addition of more water does not swell or flatten the wood. If the wood pulp sheet is low density and water is added, it flattens out to equilibrium density. If the wood pulp sheet is high density, it swells to the equilibrium density.

Equilibrium density plays a significant role when agglomerated with an absorbent material suitable for use as a cat litter. While in an air stream, if the density of the wood pulp fiber is close to the density of the composite particles formed, a homogenous blend of fibers within the composite particles may be obtained. If there is a significant difference between the density of the wood pulp and the density of the composite particles formed, there is the possibility of fiber aggregation.

Wood pulp strength is directly proportional to fiber length and dictates its final use. A long fiber pulp is good to blend with short fiber pulp to optimize on fiber cost, strength and formation of paper. In general, pulp made from softwood trees or wood grown in colder climates have longer fibers compared to pulp made from hardwood trees or wood grown in warmer climates.

Processing conditions also contribute to fiber length. When made from the same wood, chemical pulps tend to have longer fibers compared to semi-chemical pulp and mechanical pulp. Examples of long fiber pulp (>10 mm) are cotton, hemp, flax and Jute. Examples of medium fiber pulp (2-10 mm) are Northern softwoods and hardwoods. Examples of short fiber pulp (<2 mm) are tropical hardwoods, straws and grasses.

Cellulose fibers in the form of paper fluff were obtained from FEECO, Green Bay, Wis. Sodium bentonite clay was obtained from Black Hills Bentonite, Casper, Wyo. Activated carbon was obtained from Calgon Carbon Corporation, Pittsburgh, Pa. Expanded perlite (bulk density 5 lb/ft³) was obtained from Kansas Minerals, Mancato, Kans.

Fibers were added to a sodium bentonite clay litter material to assess what effect the addition of the fibers had on the litter composition's properties such as absorptivity, clump strength and odor control. The fibers were added in a manner such that a homogeneous mixture of fibers and absorbent material resulted.

Cat urine was obtained from several cats so it is not cat specific.

Experiment 1

Cellulose fibers (˜2-3 mm) were added to sodium bentonite clay (about 100-500 mesh) in a pilot plant scale pin mixer equipped with a rotary drier to form composite particles. The particles were then sieve-screened to approximately 12×40 mesh and 6×40 mesh in size. The cellulose fibers were added at 0%, 4%, and 6% levels. Each sample depicted in the tables below represents six clumps. Three of the six clumps were formed by dosing the litter composition with 10 ml of cat urine and waiting 2 hours. The remaining three of the six clumps were formed by dosing the litter compositions with 10 ml of cat urine, waiting 1 hour, then redosing with an additional 10 ml of cat urine and waiting an additional 1 hour. All six clumps were then shaken lightly for 5 seconds. The clumps were pancake-shaped and sticky to the scoop and to the touch.

Table 2 summarizes the average size, shape and strength of the clumps.

TABLE 2

| | | | | | Avg. |
|---|---|---|---|---|---|
| | Avg. | Avg. | | | Clump |
| | Longest | Shortest | Avg. | | Strength |
| | Length | Length | Height | Aspect | (% |
| Sample | (mm) | (mm) | (mm) | Ratio | retained) |
| 0% fibers (12 × 40) | 67.14 | 63.26 | 11.65 | 7.9 | 97.6% |
| 0% fibers (6 × 40) | 68.33 | 61.23 | 15.55 | 5.9 | 97.8% |
| 4% fibers (12 × 40) | 63.34 | 59.74 | 12.13 | 7.2 | 96.3% |
| 4% fibers (6 × 40) | 66.81 | 58.82 | 18.44 | 4.8 | 96.8% |
| 6% fibers (12 × 40) | 64 | 61.33 | 11.35 | 7.8 | 95.8% |
| 6% fibers (6 × 40) | 68.46 | 54.75 | 15.25 | 5.7 | 97.7% |

TABLE 3

| | Avg. Longest | Avg. Shortest | Avg. | | Avg. Clump |
|---|---|---|---|---|---|
| | Length | Length | Height | Aspect | Strength |
| Sample | (mm) | (mm) | (mm) | Ratio | (% retained) |
| 0% fibers (12 × 40) single dose | 48.33 | 46.67 | 17.67 | 3.8 | 95.10% |
| 0% fibers (12 × 40) double dose | 73.33 | 64.33 | 17.67 | 5.5 | |
| 0% fibers (6 × 40) single dose | 43.67 | 43.33 | 19.33 | 3.2 | 94.40% |
| 0% fibers (6 × 40) double dose | 70.67 | 61.67 | 20 | 4.7 | |
| 4% fibers (12 × 40) single dose | 44.5 | 44 | 17 | 3.7 | 94.50% |
| 4% fibers (12 × 40) double dose | 49 | 45 | 19 | 3.5 | |
| 4% fibers (6 × 40) single dose | 46 | 44.33 | 20 | 3.2 | 94.10% |
| 4% fibers (6 × 40) double dose | 69.33 | 56 | 22 | 4.1 | |
| 6% fibers (12 × 40) single dose | 59.33 | 54.68 | 16.67 | 4.8 | 94.30% |
| 6% fibers (12 × 40) double dose | 68.33 | 67 | 16 | 6 | |
| 6% fibers (6 × 40) single dose | 54.67 | 49 | 13 | 5.6 | 94.70% |

Experiment 2

Cellulose fibers were added to sodium bentonite clay in a pilot plant scale pin mixer equipped with a rotary drier to form composite particles. The cellulose fibers were added at 0%, 4%, and 6% levels. The composite particles were then blended with non-agglomerated bentonite clay and sieve-screened to 12×40 mesh to form a litter composition comprised of a composite blend (i.e., about 35% composite particles: about 65% bentonite clay). Each sample represents the average of three clumps formed by dosing the litter compositions with 10 ml of cat urine and waiting 2 hours (single dose) or the average of three clumps formed by dosing the litter compositions with 10 ml of cat urine, waiting 1 hour, redosing the clumps with an additional 10 ml of cat urine and waiting an additional 1 hour. Longest length, shortest length and height measurements were taken without disturbing the clumps in the box.

In addition to the clump size, the clump strength was also measured, i.e., the ability of a scoopable litter composition to form strong urine clumps which remain intact when removed from a litter box. After being measured, the clumps were allowed to sit in the box for about six hours. The clumps were then removed, placed on a wide (about ½ inch) mesh screen, shaken on a machine using lateral rotating action (about 5 lateral revolutions per second) for about 5 seconds and weighed. The clump strength is reported as Percent Retained, i.e., final weight/initial weight×100%. The higher the number, the better the clump strength. The clumps were pancake-shaped and sticky to the scoop and to the touch.

Table 3 summarizes the average size and shape of the clumps and the clump strength at the two different dosing levels and the three different fiber levels.

Experiment 3

Cellulose fibers were added to sodium bentonite clay (about 100-500 mesh) and powder activated carbon (about 25-150 μm) in a pilot plant scale drum mixer equipped with a rotary drier to form composite particles. The composite particles were sieve-screened to about 4×60 mesh. The cellulose fibers were added at 0%, 5%, and 15% levels. Each sample represents three clumps formed by dosing the litter compositions with 10 ml of cat urine and waiting 2 hours (single dose) or three clumps formed by dosing the litter compositions with 10 ml of cat urine, waiting 1 hour, redosing the clumps with an additional 10 ml of cat urine and waiting an additional 1 hour. In addition to the clump size, the clump strength was also measured using the method outlined in Experiment 2 above. Absorbent capacity was calculated by determining the weight of litter needed to absorb 10 ml or cat urine. Absorbency is reported as the grams of urine absorbed per 1 gram of litter composition.

Table 4 summarizes the average size, shape, strength and absorbency of the three clumps at different fiber and different active levels. In addition, a comparison of cellulose fiber composite particles and expanded perlite composite particles is shown.

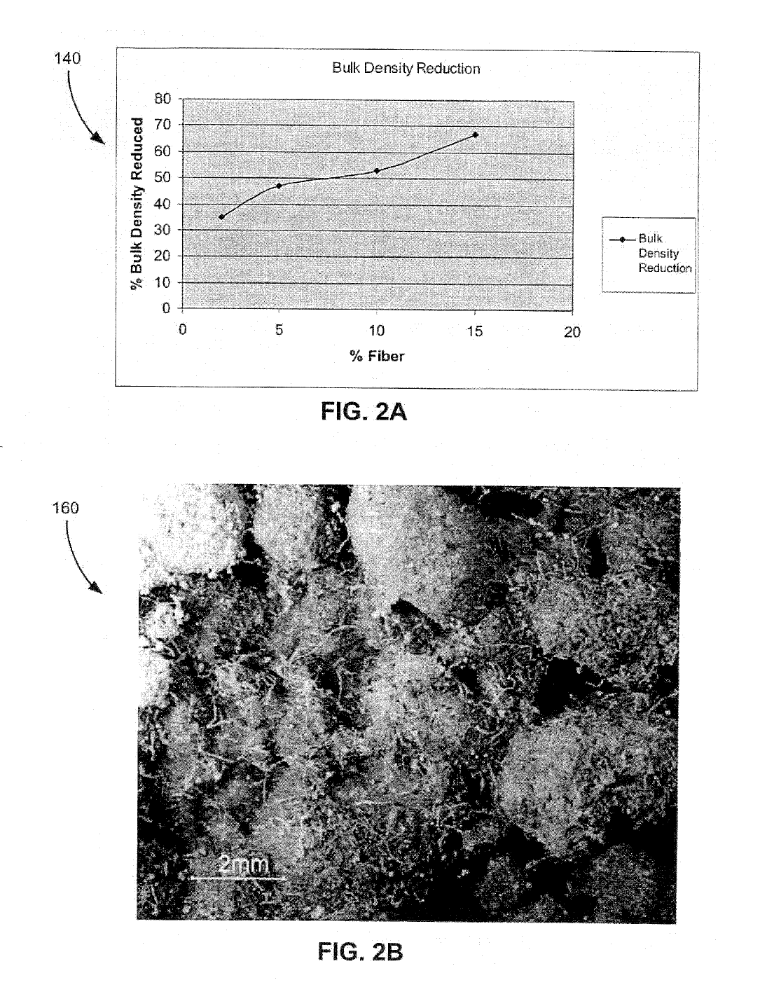

About ten percent cellulose fibers (about 2-3 mm paper fluff) were blended with about 90% bentonite (about 100-500 μm) in a drum agglomerator. The average bulk density of three different runs was calculated to be 0.46 g/cc or 28.7 lb/ft³. The average bulk density of agglomerated bentonite alone is approximately 55 lb/ft³. Thus, the addition of cellulose fibers into the composite particle provides a beneficial light-weighting effect. Table 5 lists the bulk density reduction observed with the addition of 2, 5, 10 and 15 percent paper fluff fibers. FIG. 2A is a plot 140 of the values listed in Table 5. FIG. 2B is a photograph 160 at 18 times magnification of composite particles containing sodium bentonite and 15% paper fluff fibers.

TABLE 4

| Sample (balance is | | | | | | | | | |
|---|---|---|---|---|---|---|---|---|---|
| bentonite) | | | | Avg. | Avg. | | | | Avg. |
| % | | % | | Longest | Shortest | Avg. | Avg. | Avg. | Clump |
| Paper | % | Expanded | Dose | Length | Length | Height | Aspect | Clump | Strength |
| fluff | PAC | Perlite | Type | (inches) | (inches) | (inches) | Ratio | Absorbency | (% Retained) |
| 15 | 0.5 | 0 | Single | 1.4 | 1.4 | 1.2 | 1.7 | 1.29 | 86% |
| 15 | 0.5 | 0 | Double | 1.8 | 1.9 | 1.2 | 2.2 | 1.48 | |
| 5 | 0.5 | 0 | Single | 1.6 | 1.4 | 1 | 2.1 | 0.87 | 96.40% |
| 5 | 0.5 | 0 | Double | 2.3 | 2.3 | 0.9 | 3.6 | 0.89 | |
| 0 | 0.5 | 4 | Single | 2.3 | 1.7 | 0.5 | 5.7 | 1.56 | 98.50% |
| 0 | 0.5 | 4 | Double | 2.9 | 1.8 | 0.5 | 6.8 | 1.48 | |

TABLE 5

| % Paper | Bulk | Bulk |
|---|---|---|
| fluff | Density | Density |
| fibers | (lb/ft³) | Reduction |
| 2 | 36 | 35% |
| 5 | 29 | 47% |
| 10 | 26 | 53% |
| 15 | 18 | 67% |

TABLE 6

| | | Avg. | Avg. | | | | Avg. Clump |
|---|---|---|---|---|---|---|---|
| | | Longest | Shortest | Avg. | Avg. | Avg. | Strength |
| | Dose | Length | Length | Height | Aspect | Clump | (% |
| Sample | Type | (inches) | (inches) | (inches) | Ratio | Absorbency | Retained) |
| Raw bentonite | Single | 44.6 | 43.2 | 25.8 | 2.41 | 0.44 | 94.1 |
| Raw bentonite | Double | 70.5 | 54.3 | 26.6 | 3.35 | 0.44 | |
| Composite Particles, | Single | 47 | 41.3 | 21.5 | 2.91 | 0.97 | 96.7 |
| 100% bentonite | | | | | | | |
| Composite Particles, | Double | 67.8 | 55.7 | 18.9 | 4.65 | 0.9 | |
| 100% bentonite | | | | | | | |
| Composite Particles, | Single | 53.1 | 36.6 | 15.9 | 4.06 | 1.5 | 97.6 |
| 98% bentonite, | | | | | | | |
| 2% paper fluff | | | | | | | |
| Composite Particles, | Double | 65.5 | 48.5 | 16.3 | 5.01 | 1.5 | |
| 98% bentonite, | | | | | | | |
| 2% paper fluff | | | | | | | |

Experiment 4

The absorption capacity and clumping characteristics of raw sodium bentonite, agglomerated sodium bentonite, and sodium bentonite agglomerated along with 2% paper fluff were compared. The agglomeration was performed in a pilot plant scale pin mixer and drum agglomerator equipped with a rotary drier. Composite particles as defined above were formed. Absorbency was calculated by determining the weight of litter needed to absorb 10 ml of cat urine. Absorbency is reported as the grams of urine absorbed per 1 gram of litter composition. The clumps were formed using the following method. Each sample represents three clumps formed by dosing the litter compositions with 10 ml of cat urine and waiting 2 hours (single dose) or three clumps formed by dosing the litter compositions with 10 ml of cat urine, waiting 1 hour, redosing the clumps with an additional 10 ml of cat urine and waiting an additional 1 hour (double dosed). Table 6 summarizes the average size, shape, strength and absorbency of the three samples.

Without being bound by any particular theory, it is believed that the clumping benefit results from the fibers in one composite particle grabbing onto the fibers in another composite particle providing a loading effect. It is believed that the absorption benefit results from the fact that wetting plus absorption occurs faster in fiber/clay composites than in clay-only composites or raw clay alone. Although paper fluff was used in the above experiments, incorporation of any one or more of the other types of fibers described herein into the bentonite composite particles is expected to result in a litter composition that exhibits similar clumping and absorption benefits. Similarly, although sodium bentonite was used in the above experiments, composite particles containing any one or more of the other types of absorbents described herein together with any one or more fibers is expected to result in a litter composition that exhibits enhanced clumping and absorption benefits.

If, for example, poultry feathers (such as from a chicken) are the reinforcing fiber material incorporated into the composite particle, the branched nature microstructure of the feathers will enhance the number and efficiency of connection bond points within the composite particle. This increase in connection bond points induces physical crosslinks and entanglements through feather-feather interdigitation that allow structural loads in the composite particle to be carried along the fiber, thus allowing strength in tension.

Samples having a bentonite to chicken feather ratio ranging from 100:0 to 50:50 were prepared and evaluated. The diameters of the fibers used were less than the mean diameter of the composite particles formed. At about 20% by weight of chicken feathers, the excess feathers began to extend from the composite particle surface. As the fiber length increased, the less the chicken feather mass was completely incorporated into the composite particles.

Poultry feathers incorporated into the composite particles described herein generally range in size from about 0.1-5 mm in length for single strand cuts and from about 0.1-5 mm in mean diameter and about 80 μm in mean length for planer cut shapes (inclusive of tendrils extending from the core, vanes and/or barbs). The average bulk density of the fibers is approximately 9 lb/ft³. Thus, in addition to absorptive and clumping benefits, poultry feathers can also add a lightweighting benefit to the resulting litter composition.

Odor Controlling Fibers

Odor controlling fibers may also be implemented in any of the various embodiments of the present invention. Odor controlling fibers generally refer to fibers treated with a substance that helps control odors in the vicinity of the fibers, with or without requiring contact with the source of the odors.

In one embodiment, a fibrous material, which can be an absorbent material, includes a plurality of natural fibers treated with an odor control agent, which are preferably able to withstand insults with an aqueous liquid without dissolving the odor control agent. The odor control agent may be bound to the natural fibers by a binder. The binder can be water-insoluble, and can form a highly gas permeable coating. The binder may also be highly porous, so as to expose the odor control agent to ammonia and other odoriferous gases which it is intended to control.

Cellulose fibers include fibers from wood, paper, woody plants, and certain non-woody plants. Woody plants include, for example, deciduous and coniferous trees. Non-woody plants include, for instance, cotton, flax, esparto grass, milkweed, straw, jute hemp, and bagasse. Natural fibers include cellulose fibers, carbon fibers, and other fibers existing in nature, as well as modifications of such fibers (for instance, treated cellulose fibers, activated carbon fibers, and the like).

In one embodiment, natural fibers such as cellulose, activated carbon or the like, are treated with a combination of odor control system and binder. An “odor control system” refers collectively to individual odor control agents, and combinations (by chemical reaction and/or blending) of two or more odor control agents.

In some embodiments, the odor control system includes a carboxylic acid odor control agent and the binder includes a silicone polymer, e.g., polyorganosiloxane. Silicone polymers serve as excellent binders between carboxylic odor control agents (and systems containing them) and the natural fibers.

Preferred silicon polymers are siloxane polymers based on a structure of alternating silicon and oxygen atoms with various organic radicals attached to the silicon:

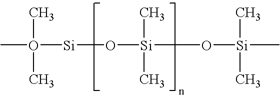

The silicone polymers have a unique ability to protect the acidic odor control agents from being dissolved or otherwise passed into solution by aqueous liquids, while at the same time permitting odoriferous gases such as ammonia to reach the odor control agents. Put another way, the silicone polymers are water insoluble, and at the same time are highly porous.

Carboxylic acid-based odor control agents include odor control agents based on carboxylic acids and/or their partially neutralized salts. Multi-carboxylic acid-based odor control agents include odor control agents based on dicarboxylic acids, tricarboxylic acids, polycarboxylic acids, etc., having two or more carboxylic acid groups, and/or their partially neutralized salts. Polymeric polycarboxylic acids refer to polymers having multiple carboxylic acid groups in its repeating units. Examples include polyacrylic acid polymers, polymaleic acid polymers, copolymers of acrylic acid, copolymers of maleric acid, and combinations thereof. Other examples are disclosed in U.S. Pat. No. 5,998,511, which is incorporated by reference in its entirety.

Another type of odor control agent includes metal ions coupled to the fiber. Examples of fibers incorporating metal ions is found in U.S. Pat. No. 6,869,537, which is herein incorporated by reference in its entirety. In one embodiment, the fiber is characterized in that at least one metal chelate-forming compound such as aminocarboxylic acid, aminocarboxylic acid, thiocarboxylic acid and phosphoric acid, which are reactive with a glycidyl group, is bonded to a molecule of a synthetic fiber through a crosslinkable compound having a reactive double bond and a glycidyl group in its molecule. The chelate-forming fiber is excellent in capturing harmful heavy metal ions and can be easily produced in a simple and safe way at a low cost. When the fibrous powdery chelate-capturing material obtained in the above manner is allowed to capture copper, silver, zinc or another metal having microbicidal activities, the resulting metal chelate fiber can impart odor-removing, deodorizing, boiocidal, antimicrobial, microbicide activity.

In one embodiment of the invention, the odor control system and silicone polymer are combined together, with the silicone polymer being in a molten form or dissolved or suspended in a solvent. The combination of odor control system and silicone polymer are applied to the natural fibers, desirably absorbent fibers such as cellulose, by spray coating, brushing, printing, dipping, extrusion, or the like.

In another embodiment of the invention, the odor control system is first applied to the natural fibers using spray coating, brushing, printing, dipping, extrusion, or the like. The silicone polymer is then applied to the natural fibers over the odor control agent using spray coating, brushing, printing, dipping, extrusion, or the like.

In one embodiment of the invention, the odor control system includes activated carbon fibers in addition to the carboxylic acid odor control agent. The silicone polymer, other natural fibers (e.g., cellulose fibers) and carbon fibers can be combined using any foregoing technique. The silicone polymer binds to the activated carbon fibers as well as to the cellulose or other natural fibers to form an integrated odor control/binder system.

In another embodiment of the invention, the odor control system includes a multi-carboxylic acid-modified chitin or chitosan complex odor control agent. The carboxyl sites facilitate absorption of ammonia and amine-based odors. The amino groups on the chitin or chitosan facilitate absorption of acid-based odor compounds, and suppress the enzymatic decomposition of urine and menses, thereby inhibiting odor generation. This odor control system can also be combined with activated carbon to provide additional control of amino, sulfuric and acidic odors.

Illustrative odor controlling fibers are described in U.S. Pat. No. 6,767,553 to Sun et al, which is herein incorporated by reference in its entirety.

Structure Directing Agent to Increase Porosity of Particles

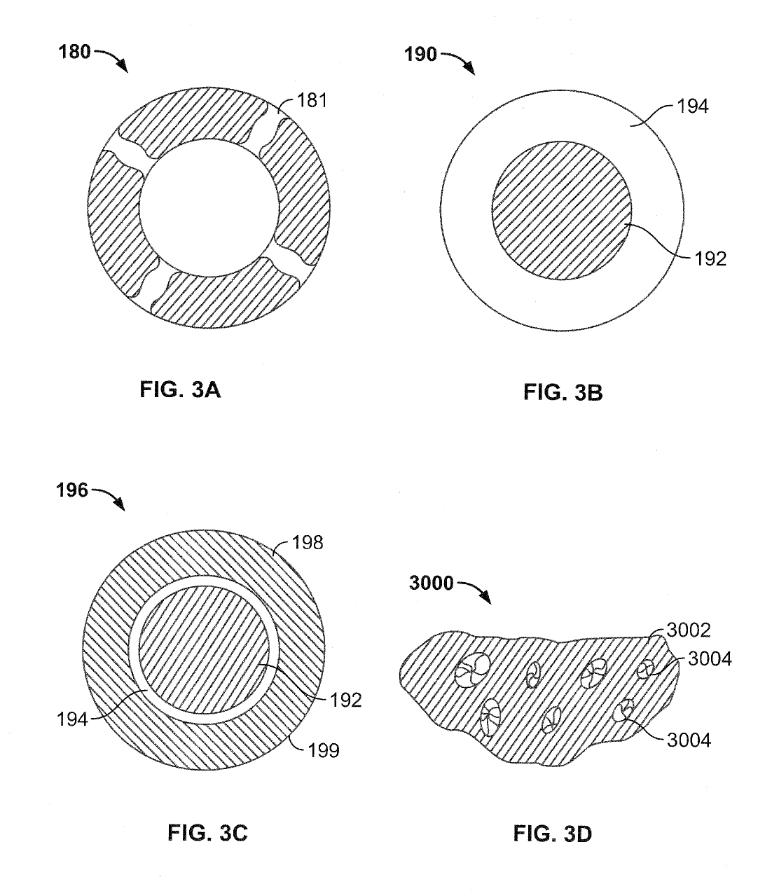

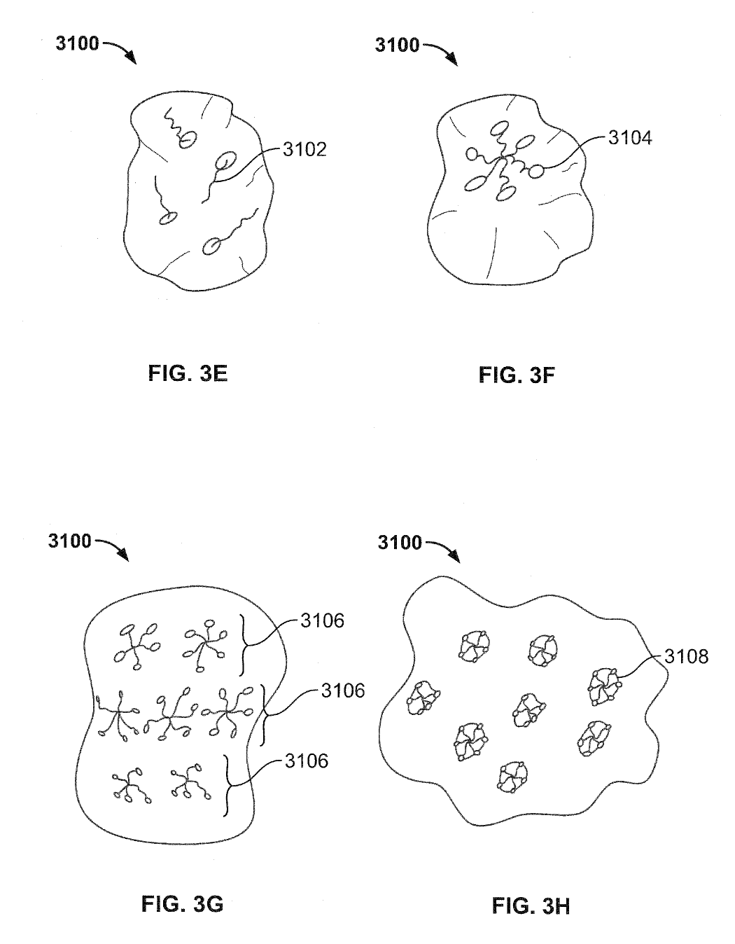

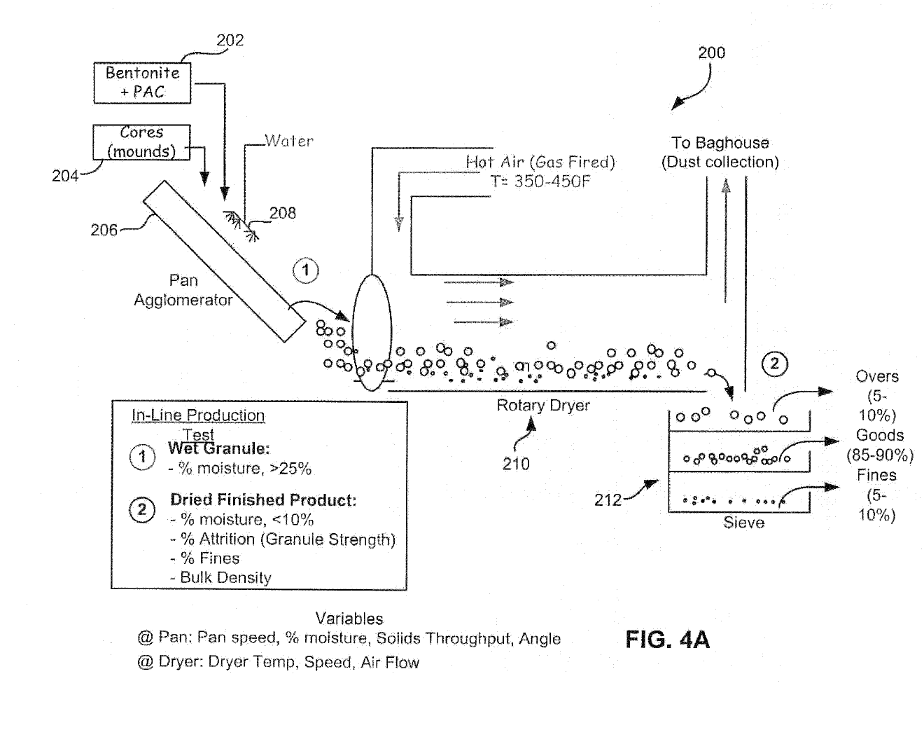

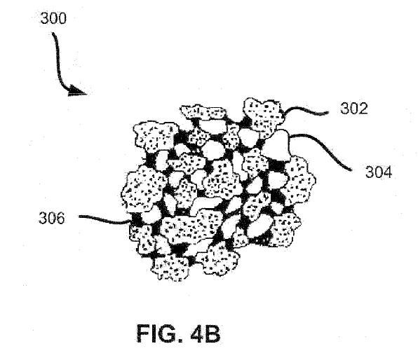

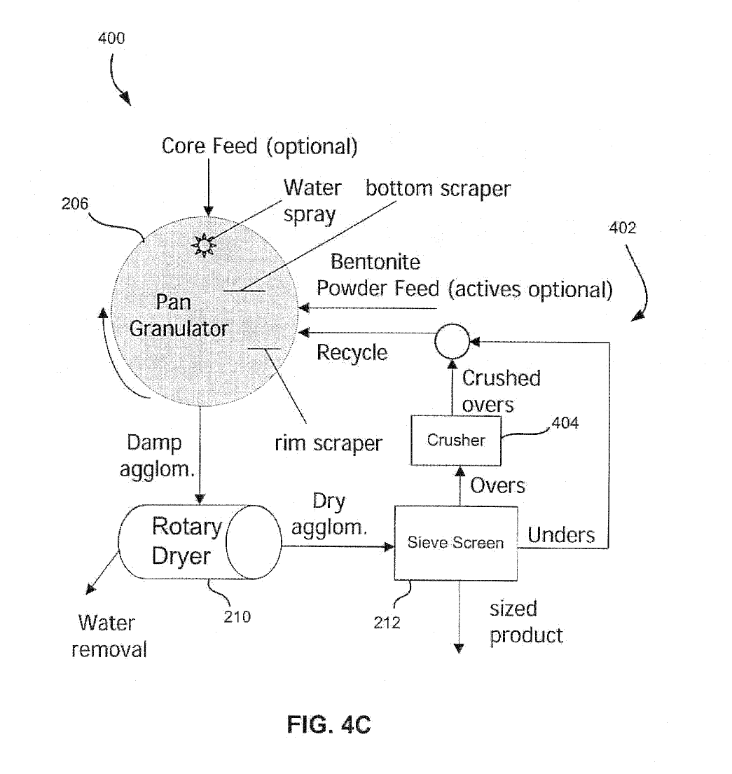

One of the great benefits of the composite absorbent particles described herein is that the particles have a lower bulk density compared to standard granular bentonite clay litters. A typical particle is shown in FIG. 4B. To further decrease the bulk density of absorbent particles, the particles may be made more porous. Particularly, composite absorbent particles according to one embodiment include an absorbent material, e.g., bentonite, that forms around surfactant micelles. For example, as shown in FIG. 3D, composite particles 3000 are formed of an absorbent material 3002 having pores 3004 where a structure directing agent once resided.

In one illustrative method of fabrication, an absorptive material such as powdered bentonite, silica, etc. is added to an aqueous solution containing the structure directing agent, e.g., a cationic surfactant, a nonionic surfactant, an anionic surfactant, etc. to create a slurry. The absorptive material interacts with the structure directing agent in the slurry, surrounding it and precipitating out. Dry and non-slurry methods are also contemplated. At least one additional method of fabrication for surfactant includes dry bed agglomeration, discussed in detail below.

In one exemplary embodiment, negatively charged bentonite materials are attracted to micelles of a cationic/nonionic surfactant to form a precipitate of bentonite surrounding the micelles. An illustrative weight percent of surfactant in the solution may be between about 1% and about 30%, but may be higher or lower. The precipitate may then be heat-treated to remove some or all of the surfactant, and optionally mixed, ground or crushed, thereby forming composite particles that are highly porous and with a low bulk density.

FIGS. 3E-H illustrate the progression of the formation of pores in a structure of absorbent material (e.g., clay), structure directing agent (e.g., surfactant) and solvent (e.g., water). FIG. 3E illustrates a particle 3100 prior to drying, with the structure directing agent 3102 present. As the solvent evaporates, the surfactant becomes more and more concentrated until it forms micelles 3104, as shown in FIG. 3F. Upon further evaporation, the micelles self-organize into periodic or quasi-periodic structures, as shown in FIG. 3G. FIG. 3H depicts the particle 3100 upon complete drying, and consequent formation of voids.

In various embodiments, the structure directing agent may interact with the absorbent material via one or more of electrostatics, hydrogen bonding, dispersion forces, etc.

The particles formed by these processes yield very high surface area material that are excellent for odor and liquid absorption. Further, the pore sizes can be tuned by selecting structure directing agents having desired properties. For example, small surfactants such as cetyl trimethyl ammonium bromide (CTAB) provide a pore size on the 2-5 nm length scale. Larger surfactants such as Pluronic® P123 from BASF provide a pore size on the 5-10 nm length scale. These pores can then be opened to absorption by removing the structure directing agents, e.g., heating and oxidizing the organic species, to produce empty channels throughout the particle. Accordingly, absorbent particles can be created with virtually any desired porosity.

Super Absorbing Materials

The active may also be a superabsorbent material (SAM). Preferably, the superabsorbent material can absorb at least 5 times its weight of water, and ideally more than 10 times its weight of water. While any SAM known in the art can potentially be used, superabsorbent polymers (SAPs) are preferred. For simplicity and to place the following embodiments in a context, much of the following discussion will refer to SAPs, it being kept in mind that other SAMs can be used interchangeably with SAP.

Because of their large absorption capacities, SAP materials are commonly used in diapers and pads to sequester excess moisture, including urine waste. However, previous dry blending of SAP particles into granular animal litters has not shown significant absorption benefits. With the introduction of the herein-disclosed agglomeration technology into cat litter products, SAP can be incorporated into most if not every granule to ensure relatively even distribution throughout the litter box. Due to this uniform distribution, preliminary experiments with SAP in agglomerates show promising absorption benefits.

Illustrative superabsorbent materials include superabsorbent polymers (SAPs) include polyacrylates such as sodium polyacrylate. SAP products include AN905SH, FA920SH, and FO4490SH, all from Floerger. Another group of illustrative superabsorbent polymers is the SNF Flocare series of products from SNF FLOERGER, ZAC de Milieux, 42163 Andrézieux Cedex, FRANCE.

In one illustrative embodiment, particles of an SAP material have been formed into a composite particle with a primary absorbent material, such as powdered bentonite clay, to produce composite particles containing SAP in all or most (>50%) of the absorbent particles. The SAP material absorbs urine or other liquid in competition with the primary absorbent material component, and as a result the absorption kinetics of these two individual components are determining factors for the overall liquid absorption performance. Because the SAP has a large effective absorption capacity relative to sodium bentonite clay, for example, it is preferred that the SAP absorb urine at least as quickly as the clay (or other absorbent material), and preferably faster, in order to maximize utilization of the larger capacity of the SAP. One observation was when the absorbent material absorbs urine faster than the SAP, the urine tends to flow down in the litter box and is no longer accessible to a given SAP particle. Another observation was that absorbed liquid in a clump tends to transfer from the clumped absorbent particles to SAP particles which causes the clump to break apart. Experiments have shown that urine is generally absorbed by clay within 3-8 seconds, and so preferred SAPs should show similar or better rates of absorption.

The ratio of SAP absorption rate to primary absorbent material absorption rate can be used to control the size of the urine clump and thus the amount of composite material required to absorb a given volume of urine. In preferred embodiments, this ratio of absorption rates for water and/or cat urine is equal to or greater than 1:1, where the rate of absorption may be defined as weight of liquid absorbed by a given mass of material in a given time period starting with initial contact with the liquid. Without wishing to be bound by any theory, the inventors believe that a ratio of absorption rates of SAP vs. sodium bentonite equal to 1:1 will reduce clump size because the SAP holds more liquid per unit volume than sodium bentonite. The inventors believe that ratios higher than 1:1 will lead to even more effective absorption and absorption-related improvements.

Where the composite particles are used as a litter, for example, control over the litter clumping and absorption behavior makes it easier for consumers to remove urine clumps because of the formation of smaller clumps compared to standard granular litters and litters with no SAP. Control over the litter clumping and absorption behavior also makes it easier for consumers to perform a complete box change because the urine penetration can be controlled to eliminate urine pooling and forming clumps at the bottom of the box that can stick to the container. Further, control over the litter clumping and absorption behavior makes it easier for consumers to refresh the box with new litter because removing smaller urine clumps means adding less new litter to refill the container to the desired volume.

Preferred SAPs may exhibit a greater Jenkins osmotic potential to water, urine, oils, and/or other liquids than the primary absorbent material in the particle. The Jenkins osmotic potential refers to the aggressiveness of a first material to attract a liquid to it relative to a second material in physical contact with the first material. The test for determining the relative Jenkins osmotic potential of two materials is as follows.
1. Place equal masses of first and second materials in physical contact with each other. The first and second materials should have about the same initial water content by weight, and not exceeding 25% of the total weight of the material.
2. Drop 1 ml of liquid per 10 grams of materials (combined) onto the interface of the first and second materials.
3. Wait 30 seconds.
4. Separate first and second materials.
5. Weigh first and second materials to determine a weight of liquid gained by each of the materials.
6. Calculate the ratio of weight gained by the first material vs. the weight gained by the second material.

Materials having an equal Jenkins osmotic potential will gain about the same amount of weight, and so will have a relative Jenkins osmotic potential of about 1:1.

In addition to the ratio of absorption rates, the particle size distribution and the overall SAP content of the absorbent particles can also be adjusted to affect the clumping and urine absorption behavior of the absorbent particles. While not wishing to be bound by any theory, the inventors believe that a smaller particle size of the SAP relative to a larger particle size of the primary absorbent material improves absorption performance due to a larger available surface area of the SAP that may be exposed to the liquid, as opposed to the case where the particle sizes of the SAP and primary absorbent material are about the same. Accordingly, it is preferred that the mean or average particle size of the SAP is smaller than the mean or average particle size of the primary absorbent material, thereby maximizing the ratio of SAP surface area to the surface area of the primary absorbent material. An illustrative ratio of average or mean primary absorbent material diameter to average or mean SAP particle diameter is greater than about 1:1, and preferably greater than about 4:1.

In illustrative embodiments containing bentonite clay and SAP, the particle size of the clay may be in a range of about 1 μm to about 1 cm. The particle size of the SAP may be in the range of about 10 μm to about 1 cm. The SAP is preferably present in about 0.5%-15% of the composition. Note that the ranges presented herein are merely for illustration of preferred embodiments, and are not meant to be limiting. Accordingly, the values may be higher or lower.

The inventors have also observed that when wet clumps of SAP- and sodium bentonite-containing particles dry out, the resulting clump is significantly harder than a comparable clump of particles not containing the SAP. This means that the clump is more apt to maintain its integrity and be removed from a container substantially in whole.

Additives may be added to the SAP particles to enhance their liquid absorption rates and/or osmotic potentials. One class of additive includes humectants such as sorbitol, glycerin, glycerin, polyethylene glycol, polypropylene glycol, etc. Humectants rapidly attract water, thereby drawing liquid to the SAP particle potentially faster than it is drawn to other materials in the composite particle. Another class of additive includes desiccants such as silica gel, calcium sulfate, montmorillonite clay, etc. A further class of additive includes deliquescents such as calcium chloride, magnesium chloride, zinc chloride, sodium hydroxide, etc. Because the liquid is preferentially attracted to the SAP particle with additive, the SAP has a greater opportunity to absorb the liquid. Such additives can be present on the surface of the SAP particles (preferred), incorporated into the SAP particles, etc.

The SAP materials used in the various embodiments may or may not include a surfactant. Surfactant-treated SAPs tend to have a faster liquid absorption rate because the contact angle at the liquid/surface interface is reduced. However, some surfactants may have a detrimental effect on clump strength.

The SAP could be incorporated using a “Differential Absorbance Model”. The “Differential Absorbance Model” proposes that a high kinetic rate/low capacity absorbent is combined with a low kinetic rate/high capacity absorbent. The first absorbent (i.e., the high kinetic rate/low capacity absorbent) would direct or funnel urine into the second absorbent (i.e., the low kinetic rate/high capacity absorbent) that would behave like a “sink”. It would be particularly advantageous if the first absorbent is able to utilize “capillary wicking forces” to achieve a greater rate of fluid transfer than the diffusion alone by channeling urine through a fast rate/low capacity region that had capillary pores or channels to a low rate/high capacity region.

One possible structure to incorporate the “Differential Absorbance Model” include hollow SAP particles 180 (FIG. 3A), e.g., spherical particles, that allows fast flow to the hollow portion in the center, e.g., via apertures 181, then slower absorption in the SAP layer. Note that the hollow portion need not be in the center of the particle as shown. Rather, those skilled in the art will appreciate that the particle may have a hollow portion that is not nearly completely encircled. Such particles may include cylindrical particles, cup shaped particles, etc. having a hollow portion where the liquid can accumulate, or even be wicked in.

FIG. 3B illustrates another possible structure 190 that includes an SAP core 192 (i.e., low kinetic rate/high capacity absorbent sink) having a permeable skin 194 that is cross-linked to resist excessive expansion but allowing expansion within a defined volume. By controlling expansion, the propensity of litter clumps breaking is reduced. In another embodiment 196, shown in FIG. 3C, an SAP core 192 is coated with a fast absorbing layer 198 having a porous outer surface 199. The fast absorbing layer 198 may absorb liquid more quickly than the SAP core 192, then allow the liquid to be absorbed by the SAP core. The SAP core 192 may have a permeable skin 194 that is cross-linked to resist excessive expansion but allowing expansion within a defined volume.

Any of the embodiments above may be agglomerated with an absorbent material. As alluded to above, these structures avoid the problem of excessive expansion which has been observed to lead to clump breakage.

Any of the cores mentioned herein can also be considered an active, for example including a lightweight material dispersed throughout the particle to reduce the weight of the particle, a core made of pH-altering material, a core made of SAP, etc.

One preferred embodiment includes actives bound directly to the surface of composite absorbent particles. The use of extremely low levels of actives bound only to the surface of absorbent particles leads to the following benefits:
1. the use of extremely small particle size of the active material results in a very high surface area of active while using a very small amount of active,
2. with actives present only on the surface of the substrate, the waste of expensive actives that would be found with ‘homogeneous’ composite particles [where actives are found throughout the substrate particles] is eliminated,
3. segregation of actives from substrates is eliminated; thus, the actives remain dispersed and do not end up on the bottom of the litter container,
4. by using very low levels of expensive actives, the cost of the product is greatly reduced,
5. binding of small particle size actives directly to the substrate surface results in lower dust levels than in bulk added product.

Surprisingly, low levels of PAC [0.2-0.3%] have been found to provide excellent odor control in cat litter when they are bound to the surface of a material such as sodium bentonite clay. For example, binding of small amounts of PAC particles to sodium bentonite substrate particles using xanthan gum or fibrillatable PTFE as binder results in litter materials with superior odor adsorbing performance. In this example, the PAC is highly effective at capturing malodorous volatile organic compounds as they escape from solid and liquid wastes due to the high surface area of the PAC, and its preferred location on the surface of the sodium bentonite particles.

PAC bound to particles of any absorbent material suitable for use as an animal litter will provide excellent odor control.

Another aspect of the invention is the use of Encapsulated Actives, where the actives are positioned inside the particle, homogeneously and/or in layers. Because of the porous structure of the particles, even actives positioned towards the center of the particle are available to provide their particular functionality. In addition, as previously mentioned, controlled degradation of the composite particles can result in controlled release of encapsulated actives. Encapsulation of actives provides a slow release mechanism such that the actives are in a useful form for a longer period of time. This is particularly so where the active is used to reduce malodors, control or kill germs, reduce sticking to the box, enhance clump strength, or as an indicator of health.

Pan Agglomeration and Other Particle Creation Processes

The agglomeration process in combination with the unique materials used allows the manufacturer to control the physical properties of particles, such as bulk density, dust, strength, as well as PSD (particle size distribution) without changing the fundamental composition and properties of absorbent particles.

One benefit of the pan agglomeration process of the present invention is targeted active delivery, i.e., the position of the active can be “targeted” to specific areas in, on, and/or throughout the particles. Another benefit is that because the way the absorbent particles are formed is controllable, additional benefits can be “engineered” into the absorbent particles, as set forth in more detail below.

FIG. 4A is a process diagram illustrating a pan agglomeration process 200 according to a preferred embodiment. In this example, the absorbent granules are bentonite clay and the active is PAC. Cores of a suitable material, here calcium bentonite clay, are also added. The absorbent particles (e.g., bentonite powder) is mixed with the active (e.g., PAC) to form a dry mixture, which is stored in a hopper 202 from which the mixture is fed into the agglomerator 206. Alternatively, the absorbent granules and active(s) may be fed to the agglomerator individually. For example, liquid actives can be added by a sprayer. The cores are preferably stored in another hopper 204, from which they are fed into the agglomerator. A feed curtain can be used to feed the various materials to the agglomerator.

In this example, the agglomerator is a pan agglomerator. The pan agglomerator rotates at a set or variable speed about an axis that is angled from the vertical. Water and/or binder is sprayed onto the granules in the agglomerator via sprayers 208 to raise/maintain the moisture content of the particles at a desired level so that they stick together. Bentonite acts as its own binder when wetted, causing it to clump, and so additional binder is not be necessary. The pan agglomeration process gently forms composite particles through a snowballing effect broadly classified by experts as natural or tumble growth agglomeration. FIG. 4B depicts the structure of an illustrative agglomerated composite particle 300 formed during the process of FIG. 4A. As shown, the particle includes granules of absorbent material 302 and active 304 with moisture 306 or binder positioned interstitially between the granules.

Depending on the pan angle and pan speed, the particles tumble off upon reaching a certain size. Thus, the pan angle and speed controls how big the particles get. The particles are captured as they tumble from the agglomerator. The particles are then dried to a desired moisture level by any suitable mechanism, such as a rotary or fluid bed. In this example, a forced air rotary dryer 210 is used to lower the high moisture content of the particles to less than about 15% by weight and ideally about 8-13% by weight. At the outlet of the rotary dryer, the particles are screened with sieves 212 or other suitable mechanism to separate out the particles of the desired size range. Tests have shown that about 80% or more of the particles produced by pan agglomeration will be in the desired particle size range. Preferably, the yield of particles in the desired size range is 85% or above, and ideally 90% or higher. The selected particle size range can be in the range of about 10 mm to about 100 microns, and preferably about 2.5 mm or less. An illustrative desired particle size range is 12×40 mesh (1650-400 microns).

The exhaust from the dryer is sent to a baghouse for dust collection. Additional actives such as borax and fragrance can be added to the particles at any point in the process before, during and/or after agglomeration. Also, additional/different actives can be dry blended with the particles.

Illustrative composite absorbent particles after drying have a specific weight of from about 0.15 to about 1.2 kilograms per liter and a liquid absorbing capability of from about 0.6 to about 2.5 liters of water per kilogram of particles. Preferably, the particles absorb about 50% or more of their weight in moisture, more preferably about 75% or more of their weight in moisture, even more preferably greater than approximately 80% and ideally about 90% or more of their weight in moisture.

Specific examples of compositions that can be fed to the agglomerator using the process of FIG. 4A include (in addition to effective amounts of active):

100% Bentonite Powder

67% Calcium Bentonite Clay (core) & 33% Bentonite Powder

50% Calcium Bentonite Clay (core) & 50% Bentonite Powder

Perlite (core) & Bentonite Powder

Sand (core) & Bentonite Powder

The following table lists illustrative properties for various compositions of particles created by a 20″ pan agglomerator at pan angles of 40-60 degrees and pan speeds of 20-50 RPM. The total solids flow rates into the pan were 0.2-1.0 kg/min.

TABLE 7

| | | Bentonite to | Final | Bulk Density | Clump |
|---|---|---|---|---|---|
| Core | Water | Core Ratio | Moisture | (kg/l) | Strength |
| None | 15-23% | 100:0 | 1.0-1.4% | 0.70-0.78 | 95-97 |
| Calcium | 15-23 | 50:50 | 3.4 | 0.60-0.66 | 95-97 |
| bentonite | | | | | |
| Calcium | 15-18 | 33:67 | 4.3-4.4 | 0.57-0.60 | 93-95 |
| bentonite | | | | | |
| Sand | 10-12 | 50:50 | 2.0 | 0.81-0.85 | 97-98 |
| Sand | 6-8 | 33:67 | 1.6-2.4 | 0.92 | 97 |
| Perlite | 15-19% | 84:16 | | 0.36-0.39 | 97% |
| Perlite | 16-23% | 76:24 | | 0.27-0.28 | 95-97% |

Clump Strength Test. Clump strength is measured by first generating a clump by pouring 10 ml of pooled cat urine (from several cats so it is not cat specific) onto a 2 inch thick layer of litter. The urine causes the litter to clump. The clump is then placed on a ½″ screen after a predetermined amount of time (e.g., 6 hours) has passed since the particles were wetted. The screen is agitated for 5 seconds with the arm up using a Ro-Tap Mechanical Sieve Shaker made by W.S. Tyler, Inc. The percentage of particles retained in the clump is calculated by dividing the weight of the clump after agitation by the weight of the clump before agitation. Referring again to the table above, note that the clump strength indicates the percentage of particles retained in the clump after 6 hours. As shown, >90%, and more ideally, >95% of the particles are retained in a clump after 6 hours upon addition of an aqueous solution, such as deionized water or animal urine. Note that ≧about 80% particle retention in the clump is preferred. Also, note the reduction in bulk density when a core of calcium bentonite clay or perlite is used.

FIG. 4C is a process diagram illustrating another exemplary pan agglomeration process 400 with a recycle subsystem 402. Save for the recycle subsystem, the system of FIG. 4C functions substantially the same as described above with respect to FIG. 4A. As shown in FIG. 4C, particles under the desired size are sent back to the agglomerator. Particles over the desired size are crushed in a crusher 404 and returned to the agglomerator.

The diverse types of clays and mediums that can be utilized to create absorbent particles should not be limited to those cited above. Further, unit operations used to develop these particles include but should not be limited to: high shear agglomeration processes, low shear agglomeration processes, high pressure agglomeration processes, low pressure agglomeration processes, mix mullers, roll press compacters, pin mixers, batch tumble blending mixers (with or without liquid addition), and rotary drum agglomerators. For simplicity, however, the larger portion of this description shall refer to the pan agglomeration process, it being understood that other processes could potentially be utilized with similar results.

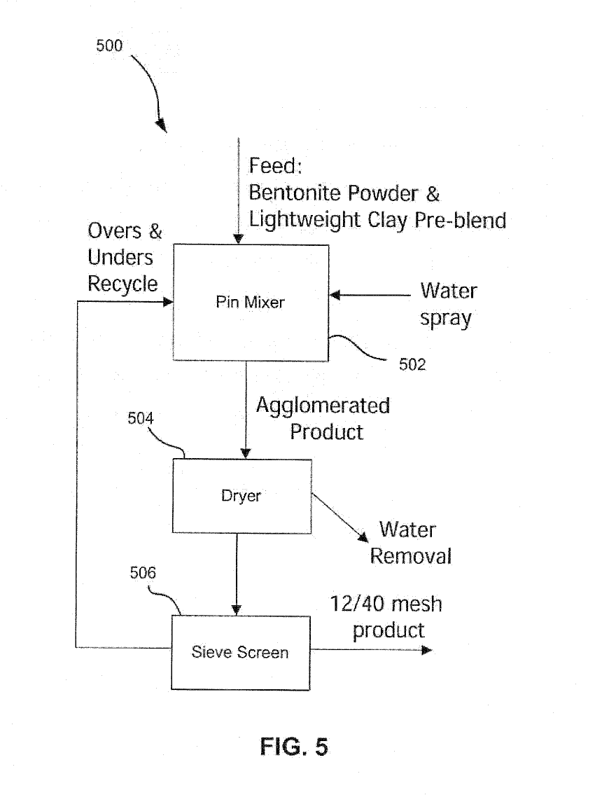

FIG. 5 is a process diagram illustrating an exemplary pin mixer process 500 for forming composite absorbent particles. As shown, absorbent particles and active are fed to a pin mixer 502. Water is also sprayed into the mixer. The agglomerated particles are then dried in a dryer 504 and sorted by size in a sieve screen system 506. The following table lists illustrative properties for various compositions of particles created by pin mixing.

TABLE 8

| | Bentonite | | | |
|---|---|---|---|---|
| | to | Water | Bulk | Clump Strength - |
| Lightweight | Clay Ratio | Addition | Density | 6 hours |
| Clay | (wt %) | (wt %) | (lb/ft³) | (% Retained) |
| Zeolite (39 lb/ft³) | 50:50 | 20 | 59 | 91 |
| Bentonite (64 lb/ft³) | 100:0 | 20 | 67 | 95 |

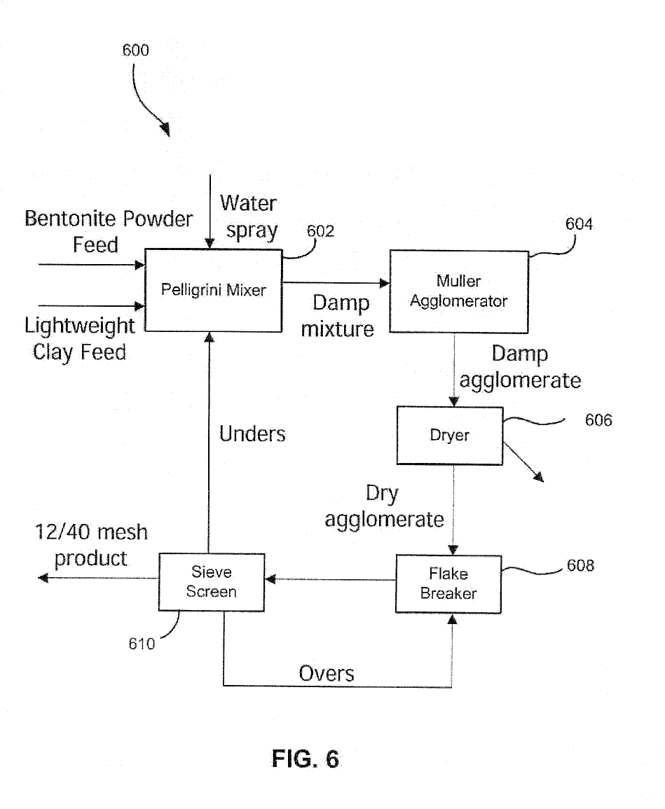

FIG. 6 is a process diagram illustrating an exemplary mix muller process 600 for forming composite absorbent particles. As shown, the various components and water and/or binder are added to a pellegrini mixer 602. The damp mixture is sent to a muller agglomerator 604 where the mixture is agglomerated. The agglomerated particles are dried in a dryer 606, processed in a flake breaker 608, and then sorted by size in a sieve screen system 610.

The following table lists illustrative properties for various compositions of particles created by a muller process. Note that the moisture content of samples after drying is 2-6 weight percent.

TABLE 9

| | | | Calculated | Actual | Clump | |
|---|---|---|---|---|---|---|
| | | | Bulk | Bulk | Strength - | |
| | Bentonite:Clay | Water Addition | Density | Density | 6 hours | Dust |
| Clay | (wt %) | (wt %) | (lb/ft³) | (lb/ft³) | (% Retained) | (mg) |
| GWC | 50:50 | 33 | 43 | 45 | 83 | 39 |
| (32 lb/ft³) | | | | | | |
| GWC | 50:50 | 47 | 43 | 42 | 56 | 34 |
| (32 lb/ft³) | | | | | | |
| Taft DE | 50:50 | 29 | 33 | 46 | 86 | 38 |
| (22 lb/ft³) | | | | | | |
| Taft DE | 50:50 | 41 | 33 | 43 | 76 | 35 |
| (22 lb/ft³) | | | | | | |

Recovery of Materials From Other Processes for Incorporation in Composite Particles

Raw materials for the particles described herein may be captured from waste streams or by-product streams of other processes. The current disposition of much of this material is disposal thereof as a solid waste stream. The ability to use this material to enhance the functionality of an engineered absorbent system would allow the material to be recycled in a value added product.

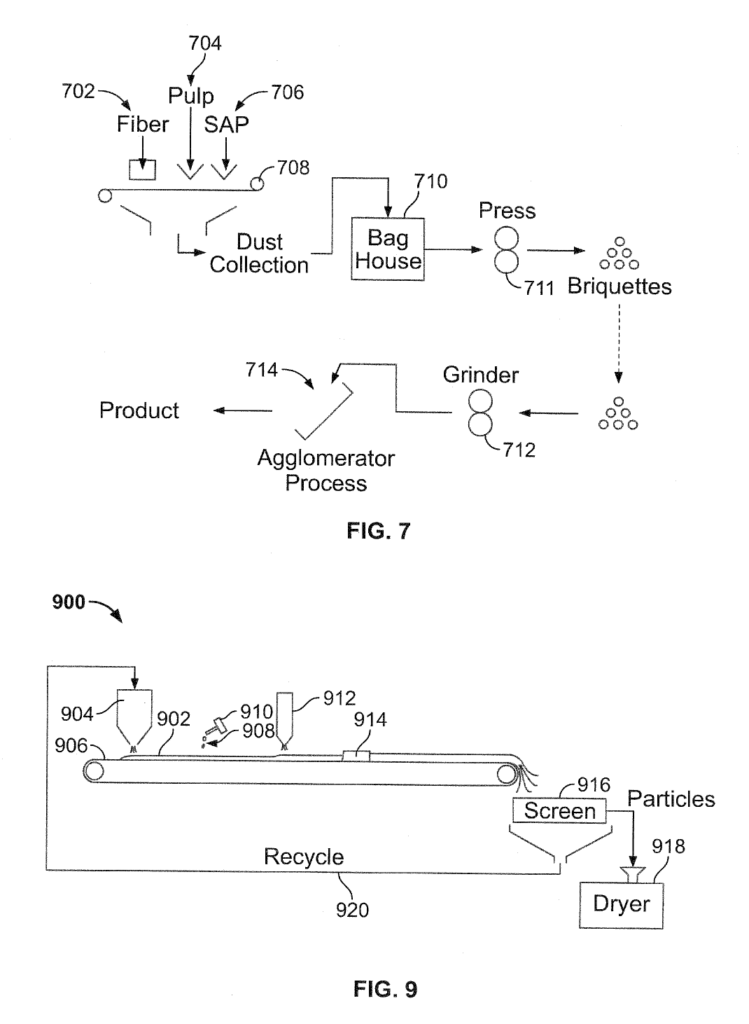

FIG. 7 illustrates how one or more materials can be recovered from another unrelated process and implemented in conjunction with various embodiments of the present invention. In this example, assume products containing pulp (e.g., wood pulp), nonwoven materials and SAMs are being produced in an airlaid nonwoven process. Examples of these include diapers, absorbent sheets for medical and other applications, etc. As shown, fiber 702, pulp, 704, and SAP 706 are applied to a rollstock 708. Pulp and SAP dust from the process is collected and sent to a bag house 710, where larger fines may be collected and bagged. The captured dust is formed into a briquette by a press 711. For example, briquettes may be transported to another facility (if necessary), ground in a grinder 712, and agglomerated with an absorbent material, e.g., sodium bentonite, in an agglomerator 714 or other processor to form a composite particle. The collection on the baghouse sock subjects the fine particles to a random layering that yields a more uniform presentation of each type of particle to the other allowing for a coupling type of functionality. The briquetting and regrinding of the mixed material uniquely distributes the two components, as well as allows their transport. Note also that pulp and SAM fines in the briquetted bag house waste can also be captured and used in the composite particles. The composite particle should have super absorbing, fibrous strength, and surface tack properties for use in product articles.

The pulp absorbs water more quickly than the SAM, and so is able to quickly immobilize the water to make it available for transfer to the SAM. Some SAMs prefer the water to be first immobilized for its maximum absorption.

Dry Bed Agglomeration Process and Illustrative Equipment

The techniques for agglomerating powders into granular material described above involve the mixing of water, powder, and (optionally) some binder together, along with the application of some kind of mechanical force to form discrete particles.

One embodiment of the present invention is a novel process for agglomerating powders into particles. By using the inherent sphericity and uniformity of liquid drops, this process creates substantially uniform-sized, spherical or controlled-shaped agglomerated particles. The process is robust and stable, and avoids many of the drawbacks of standard mechanical agglomeration methods. Although described below primarily in terms of creating absorbent particles, e.g., litter, this agglomeration technique could be used for any powder agglomeration application.

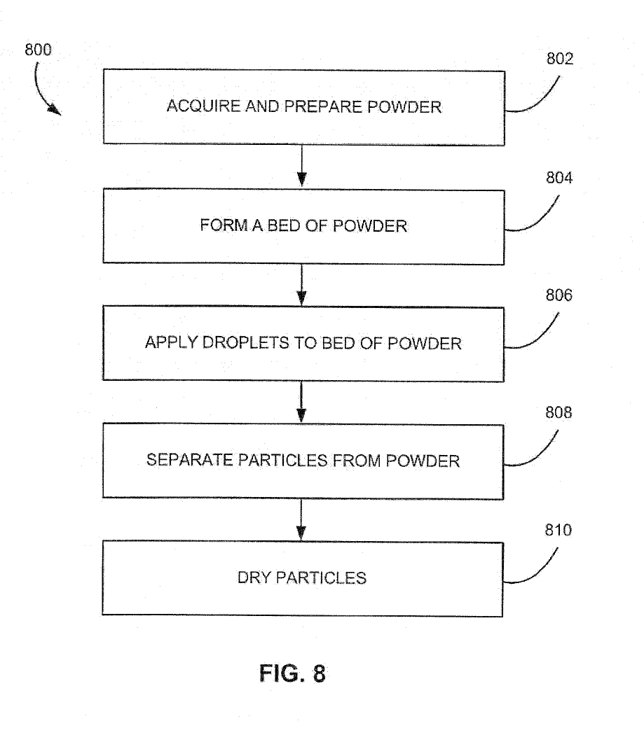

FIG. 8 illustrates a general method 800 for dry bed agglomeration according to one embodiment of the present invention. In step 802, a powder is acquired, and if necessary, prepared. For example, if the powder contains multiple components, the components are dry mixed. In step 804, the powder is placed on a substrate or in a chamber to form a bed. In step 806, droplets of a liquid are formed and applied to (e.g., dropped on) the bed. In step 808, the newly formed particles are separated from the dry powder, e.g., by screening. In step 810, the particles are dried.

One of the advantages of this invention is that processing can be done using simple off-the-shelf equipment. All of the processing described should be possible with a gentle powder mixer, a conveyor belt, simple tubing to create the droplets, and a screener. The process can include additional treatment after formation such as a tumbler to increase roundness and/or attrition, rollers to flatten the particles, etc.

With reference to step 802 of FIG. 8, the powder can be any composition, and most if not all of the materials listed herein may be used. Preferably, the powder includes at least one component that creates a binding mechanism when dry. Sodium bentonite inherently has this property. Any of the materials described herein may be used in the process. One preferred absorbent material is sodium bentonite having a mean particle diameter of about 5000 microns or less, preferably about 3000 microns or less, and ideally in the range of about 25 to about 150 microns.

An advantage of this process is that moisture-triggered additives can be used that might in other processes build up on the surfaces of the equipment. In this process, only the agglomerates themselves receive the moisture; the rest of the dry powder is unaffected. For this reason, the powder composition can also contain an additional liquid-activated agent that would be impractical in other moist-bed processing systems. Thus, a binder can be mixed into the powder, and will only activate in the newly formed particle. Similarly, a gas forming agent can be used to create foamed particles. For example, plaster of paris can be used for binding or bicarbonate/citric acid can be used as a gas forming agent for foamed litter.

Other binders such as natural, modified and synthetic polymers, water soluble film and gel formers, may be used for agglomerate-binding or improved product clumping. Fibrous materials (cellulose, plastic, etc.) can be added to increase the particle strength or product clump strength.

For lightweight litter, one illustrative composition for the powder would be bentonite (creates binding), a lightweight additive (such as perlite, sawdust, or other material weighing less than the bentonite), carbon powder, and optional additives, but could be a simple as pure bentonite.

It should be kept in mind that this aspect of the present invention is not limited to litter particles, but could be used to create agglomerates using any powder, for any application. The bed properties can be controlled by the composition of the powders (lightweight materials such as perlite to decrease density), the depth of the bed, the amount of vibration, air from below to lighten the bed, and the angle of the bed.

With reference to step 804 of FIG. 8, the dry bed of powder can be created on or in the form of a moving substrate such as a conveyor belt, a vibratory bed, a fluid bed, a stationary substrate, etc. The bed is preferably created and maintained at a relatively consistent composition and density.

With reference to step 806 of FIG. 8, to create the agglomerates, a liquid is emitted from an orifice to create individual drops. The liquid may include water, a solution of water and additives, or nonaqueous components. Illustrative additives in the solution used to form the drops include antimicrobials, binders, colors, etc., which advantageously may be delivered uniformly to each particle, or selectively to some particles and not others. Surfactants may be added to control the size of the droplets.

The drops can be formed naturally, growing, terminating, and dropping due to the interplay of surface tension, gravity and the surface properties of the orifice. Or, they can be formed by mechanical means by a pulsing sprayer, peristaltic pump, etc. If developed naturally, the weight of the drops are approximated by the formula
mg=2πaλ cos α
where a is the tube radius, λ is the surface tension of the liquid and α is the angle of contact with the tube. Accordingly, the size of the drops can be controlled by the tube size and other factors, or be controlled by mechanical means.

Once emitted, the drop naturally takes on a spherical shape due to the need to reduce surface energy. The drop is allowed to fall onto a dry bed of powder and absorb the powder it comes in contact with to form a generally spherical or sub-spherical particle. The size and shape of the particle is determined by one or more processing conditions including droplet size, force in which the droplet hits the bed, the density of the bed, the thickness of the bed, the absorptive properties and hydrophilicity/phobicity of the powder, and the post treatment. For instance, the fundamental size of the droplet is the primary determining factor for the final particle size. Unlike other agglomeration methods whose particle size and distribution output depends on a dynamic balance of mechanical factors and can fluctuate easily, the size, shape and density of the particles in this novel process are relatively fixed by the initial conditions.

Thus, the agglomerated particle size and particle size distribution can be accurately engineered directly from the initial water drop size. This in turn makes the process very stable and predictable, since it is dependent on physical parameters and not significantly dependent on an equilibrium of mechanical forces.

The particles can be designed to be any size. An illustrative, nonlimiting average particle diameter range for particles primarily of sodium bentonite formed with water droplets is from about 0.1 mm to about 1 cm.

Further, the process is very scalable, as the particle size and particle size distribution can be consistently delivered even as the process is scaled up, since the process is not significantly dependent upon equipment or a dynamic equilibrium that is scale-dependent.

The inventor has surprisingly found that compositions that are predominantly bentonite can be processed to form hollow particles, which also results in a low bulk density of the particles. Without wishing to be bound by any theory, it is believed that the powder adheres to the outer surface of the droplet. As water is absorbed by this outer shell, it is drawn out of the center of the particle, thereby leaving a hollow center.

The composition and/or processing conditions can be used to control the shape of the particles also. For example, the inventor has surprisingly found that compositions that are predominantly bentonite can be processed to form a generally bagel-shaped or generally cupped-shape particle. Without wishing to be bound by any theory, it is believed that in some cases, the cupping or bagel shape is a result of the particles collapsing into the hollow core. In other cases, it is believed that deformation of the droplet upon impact is responsible for the shape. In yet other cases, a combination of the two phenomenon may be responsible. Regardless of how the shapes are formed, the cupped or bagel shaped particles can have advantages in creating more permeability and air space in the particle packing and lowering the bulk density of the particles.

These findings were unexpected. The inventor believes that similar results may be obtained with other materials as well.

The same or a different powder can be added to the particle to further increase its size, make it less tacky for later separation from the bed, prevent the particles from ticking together, etc. For example, the bed can include a dusting or sprinkling mechanism from the top to fully cover the agglomerates in dry powder, or have some other means of modifying or plowing the bed. The particles can also be rolled. Again, a plow can be used. Testing showed that creating a tumbler or drum for the particles was possible, but provided opportunity for overlapping drops and multiple particles to become fused together.

In another variation, drops of differing volume are applied to the bed of powder to create particles of two different sizes.

Particle shape can be controlled directly by drop force, droplet pattern, and/or composition, and/or can be created by secondary shapers such as rollers (a dry powder coating on the particles makes this feasible).

With reference to steps 808 and 810 of FIG. 8, after the particles are formed, they are easily screened from the dry powder and sent for drying. The dry powder may be recycled back to be part of the dry bed. The screening is of mostly dry material, but it may be desirable to use a heated screen, or a screen that has some self cleaning ability, since some particles may adhere to the screen at times. An optional polishing screener may be positioned after the dryer. An angled screen may be helpful in providing both screening of the powder and conveyance of the particles to the dryer.

Illustrative drying processes include air drying with ambient air, air drying with heated air, radiant heat drying, tumbling in combination with air drying, cycloning, etc.

A benefit of this process is that the separation of the particles from the bed may be performed prior to drying. The only material that is dried is of the desired size, so there is a very high yield from the dryer, and the only drying energy needed is of water inside the sized particles.

The dry bed processes described herein may be used in a plethora of applications. One such application is creation of an animal litter having, for example, one or more of the following properties or ingredients: borate ammonia control, activated carbon, lightweight ingredients, addition of binders, functional speckles, solid waste encapsulation, super absorbent polymers, particle size modifications, non-stick litter, and use of different minerals (e.g., zeolite). Other binders that could be used for agglomerate-binding or improved product clumping, in addition to those already listed herein, are natural polymers such as galactomannan or polysaccharide. gums and starches (guar gum, alginate, chitosan, xanthan, carrageenan)), synthetic water-reactive polymers such as modified starches, modified cellulose (CMC), water soluble film and gel formers such as PVP, PEG, PVA, acrylates or similar materials. Fibrous materials (cellulose, plastic, etc.) can be added to increase the particle strength or product clump strength.

FIG. 9 illustrates an illustrative system 900 for creating composite particles by dry bed agglomeration. As shown, powder 902 is held in a hopper 904, and applied to a conveyor belt 906. The powder can be applied in a relatively uniform thickness, or a distributor bar (not shown) can grade the powder to the desired bed height.

Liquid droplets 908 are formed by a droplet forming mechanism 910 that includes emitter tubes having an orifice shape, size and angle to produce drops of a predetermined size at a selected flow rate. The system can be in the form of a spinning disk sprayer to allow for rapid flow through of agglomerate production.

A prototype system used a series of syringes create the droplets. Also, the height of the droplet forming mechanism 910 may be adjusted to set the distance that the droplets fall to the bed. At this point, the particles begin to form at about the point of contact of each droplet with the bed. Note that the point of contact is relative to the bed, and so will move with the bed, e.g., along the conveyor belt.

A second powder distributing mechanism 912 may provide a layer of powder over the forming particles as they pass thereby. A plow 914 may also or alternatively disrupt the bed to apply additional powder to the particles. Vibrating the bed may also be employed.

The particles and powder fall off the end of the conveyor belt into a vibrating screen 916, which separates the particles from the powder. The particles are sent to a dryer 918. The powder is sent to the hopper 904 via a recycle line 920. Oversize and undersized particles may also be recycled.

As mentioned above, a structure directing agent may be used during fabrication of the various particles found herein to increase the porosity of the resultant particle. In a dry bed agglomeration process, a structure directing agent can be used to create nanoscopic pores. For instance, where particles formed by the dry bed agglomeration process have an average pore diameter of 10-500 microns, the inclusion of a structure directing agent in the process may create pores on the order of 1 nanometer to a few microns in diameter.

In one illustrative embodiment, a surfactant is included in the droplets that form the particles. Suitable surfactants include cetyl trimethyl ammonium bromide (CTAB), Pluronic® P123 from BASF, etc. As the solvent evaporates, the droplet will concentrate the surfactant until it forms micelles, which can self-organize into periodic or quasi-periodic structures.

In various embodiments, the structure directing agent may interact with the absorbent material via one or more of electrostatics, hydrogen bonding, dispersion forces, etc.

Shaped Particles

As alluded to above, cat litters are commonly used to sequester cat waste into a central location that is relatively easy to maintain and clean. An effective clumping cat litter controls odors, readily absorbs urine waste to produce strong urine clumps, and minimizes litter tracking outside the box. One mechanism that may be used to control these attributes is optimizing the shape of the litter particles. A shaped litter formulation can improve upon existing urine absorption, urine clumping, and tracking behaviors using the proper granule shape(s). The exact shape(s) depends on the behavior desired, and embodiments may also include different amounts of different shapes to control void space, surface area, and propensity to stick to cats' paws.

Absorbent materials with shaped granules may provide multiple benefits over products without shaped granules, including enhanced urine absorption, decreased urine penetration toward the bottom of the litter box, stronger waste clumps, less sticking, and decreased tracking of litter out of the litter box into the surrounding environment. The clay minerals, cellulosic materials, and other materials listed herein can potentially be formed into virtually any shape. While many materials listed herein are commonly found in animal litters, the creation and use of shaped granules as described herein is generally applicable to any absorbent material. Further, the particles may be composite particles, particles of a single material, or combinations thereof.

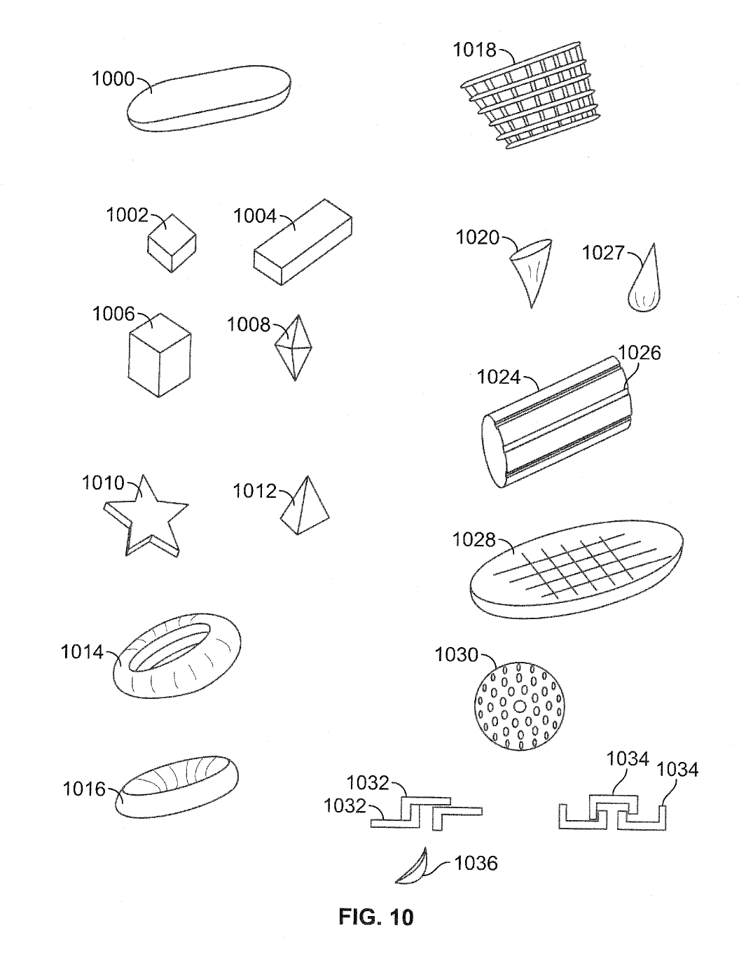

The particles can be formed into any desired shape, and many illustrative shapes have been contemplated for the absorbent particles. It should be kept in mind that the following list of shapes is nonexhaustive. It should also be kept in mind that portions of the various particles can be combined with portions of other particles to form a nearly unlimited combination of features in a single particle. FIG. 10 illustrates several potential shapes. As shown, particle 1000 has a flat form, disc-like profile. Particle 1002 is generally square shaped and has a flat form, i.e., low profile, while particle 1004 is generally rectangular shaped and has a flat form. Flat form particles such as these inhibit penetration, and enhance clumping because the particles tend to overlap in the container. Flat forms also lower tracking as flat forms are less apt to stick to animal fur.

Particle 1006 is a generally rectangular particle, and has a generally square profile when looking at its ends. Particle 1008 is diamond shaped. Particle 1010 is generally star shaped. Particle 1012 is generally shaped like a tetrahedron or pyramid. Particles with flat sides exhibit less tracking than spherical particles, as the flatness of the particles tends to make it less likely to become bound up in an animal's fur, between toes, etc. Particles with flat sides also tend to exhibit better clumping, as the abutting surface area of the particles is maximized. Additionally, for spill cleanup, flat sides allow particles to lie flat against a surface, maximizing the surface area in contact with the spill.

Particle 1014 is cupped. The cupped shape beneficially decreases the overall bulk density of the material, while liquids are caught in the cups, thereby reducing penetration.

Particle 1016 is generally bagel shaped. Particle 1018 is mesh shaped. Particle 1020 is generally cone shaped. Particle 1022 has a combination of cone and hemisphere shapes.

Particle 1024 is generally cylindrical. This particle 1024 also exhibits how grooves 1026 may be added to a particle to increase its surface area and reduce bulk density.

Particle 1028 exhibits how a particle may be scored to increase its surface area, as well as provide resistance to liquid flow therearound.

Particle 1030 is a generally spherical particle illustrating how dimples may be added to a particle to increase its surface area.

Particles 1032 have angled portions along one side thereof. Particles 1034 have angled portions along more than one side thereof. In some embodiments, the angled portions may allow the particles to exhibit some type of interlocking. Particles that provide some type of interlocking increases clump strength due to the interlocking of the particles. Interlocking particles may also contain features that cause water to collect thereon, thereby reducing liquid penetration.

Particle 1036 has a crescent shape.

In general, an illustrative lower end of average particle length or diameter is about 1 mm, as sizes smaller than about 1 mm tend to lose benefits associated with particular particle orientations (how particles tend to align with respect to each other). The upper end of average particle length or diameter is virtually unlimited. For animal litters, a preferred upper end of average particle length or diameter is less than about ½ inch.

Illustrative aspect ratios of the particles, presented by way of example only, may be any value meeting length:height≧2:1, length:diameter≧2:1, and diameter:height≧2:1.

The shaped particles can be formed using many processes, including but not limited to extrusion, agglomeration, pressing including roll pressing, stamping, dry bed agglomeration, punch roller processing, hammer mill processing, molding, flash drying (e.g., spray slurry onto hot roller), etc. For example, composite absorbent particles formed in the pan agglomeration process described above are substantially spherical in shape when they leave the agglomeration pan. At this point, i.e., prior to drying, the particles typically have a high enough moisture content that they are malleable. By molding, compaction, or other process, the composite absorbent particle can be made into non-spherical shapes such as, for example, ovals, flattened spheres, hexagons, triangles, squares, etc. and combinations thereof. Variations on spherical shapes can also be provided. The shaped particles may be executed in both clumping and non-clumping litters.

Embodiments of the present invention also include combinations of various shapes to create consumer products that provide enhanced benefits over absorbent materials currently on the market. For example, smaller particles may be mixed with larger particles. The smaller particles fit into voids, depressions, etc. in or between the larger particles, thereby minimizing liquid penetration.

The fact that particles in a container tend to shift during movement, e.g., when an animal steps and digs in the litter, as the litter is transported, etc. can also provide advantages in terms of targeted segregation. In other words, one can take advantage of the known segregational behaviors of various particles to provide targeted benefits. For example, large flat particles will tend to rise to the surface of the litterbox, while smaller particles will aggregate towards the bottom. Thus, for example, smaller particles exhibiting low liquid penetration and/or greater liquid absorption can be combined with larger particles exhibiting greater odor control. In one embodiment, a smaller particle containing SAP can be admixed with larger particles containing activated carbon. The smaller particles have less void space therebetween and/or will absorb more liquid, thereby limiting penetration. The larger particles control odors. A variation may use identically-shaped particles, where the odor-controlling particles have a lower bulk density, e.g., due to lightweight additives, lightweight core, etc.

A further variation has larger particles that segregate towards the bottom of the pan, while smaller particles aggregate at the top of the box. Here, the larger particles may have a greater bulk density than the smaller particles to induce such segregation. An example of this may include larger cylindrical particles (e.g., particle 1024) with smaller hollow spherical particles.

In a similar way, the way litter segregates in the bag during shipment can be taken advantage of to provide, for example, a litter having particles with particular properties segregated in a predefined way. Then, for instance, when the consumer pours the litter into the litter box, the predefined particle distribution will be inversely transferred to the litter box. Going further, the particles initially positioned or tending to settle to the bottom of the bag during shipment, now out of the bag and on top of the container, will segregate down to the bottom with use. This may allow particles with odor controlling properties to move downward towards the bottom of the pan as their effectiveness is consumed. Likewise, relatively unaffected particles initially positioned towards the bottom of the pan migrate towards the top over time, thereby providing long term odor control benefits.

In other embodiments, absorbent particles having the same shape but different properties may be provided, and have about the same size or different sizes. In further embodiments, particles having different shapes but about the same size can be provided.

Accordingly, shaped particles having certain desirable benefits can be combined with particles of other shapes and complementary benefits to provide a plethora of desirable results.

FIG. 11 depicts a method 1100 of using absorbent particles. In step 1102, the user pours first and second absorbent particles having different shapes into a container such as a litterbox. In step 1104, the user agitates the particles to induce targeted segregation. The particles may be agitated by physically contacting the particles, e.g., by stirring, scratching, etc. The particles may also be agitated by shaking the container.

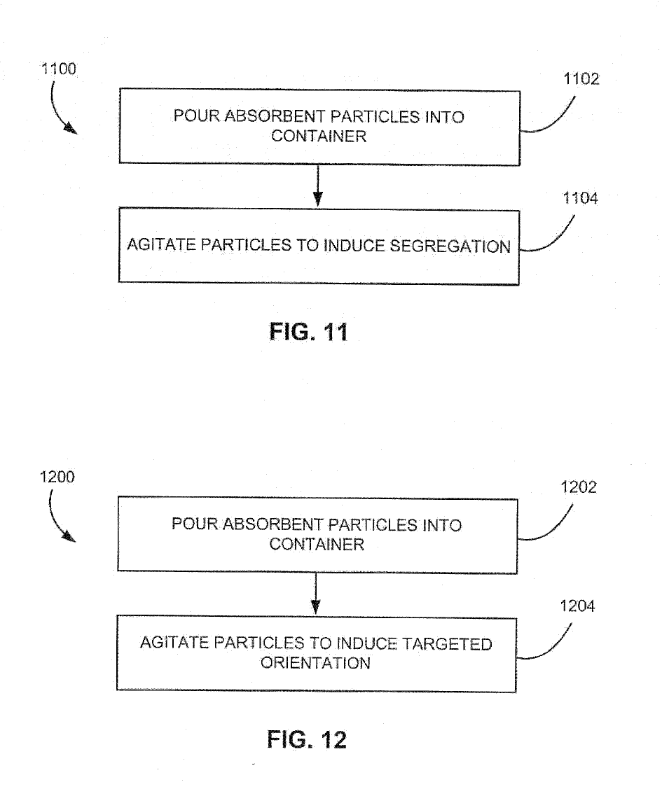

FIG. 12 depicts a method 1200 for orienting particles. In step 1202, the user pours absorbent particles, which may or may not have different shapes, into a container. In step 1204, the user agitates the particles to induce a targeted orientation. Again, the particles may be agitated by physically contacting the particles, by shaking the container, enabling an electronic device such as an automatic litterbox with a moving rake to contact the particles, etc.

A targeted orientation may be virtually any orientation that may be provided by agitating the particles. For example, flat form particles can be agitated so that many of them lie generally coplanar with the bottom of the container. This in turn maximizes the surface encountered by a liquid entering the container, thus minimizing penetration. Another example includes agitating the particles to orient smaller particles in voids created between larger particles. Yet another example includes orienting the particles so that flat surfaces of some particles abut with flat surface of other particles, thereby creating a more tortuous path for liquids passing from the top of the container downward. Yet another example includes agitating interlocking particles to induce the interlocking. Those skilled in the art will appreciate that the number and ways of orienting the various possible combinations of types of particles is nearly infinite.

Particles may also be shaped in various combinations to minimize penetration in automatic litterboxes. One of the predominant issues in automatic litterboxes is liquid penetrating to the bottom, causing litter to stick to the bottom.

Further embodiments vary combinations of the particle shape(s), ratio of combinations of particle shapes, particle size, and addition levels to further optimize the litter performance.

Accordingly, using particles of a particular shape or shapes may make it easier for consumers to:
1. Scoop waste clumps from the litter box because they may form smaller, stronger clumps compared to standard litters. The clumps may be smaller and stronger because the granule size and shape can be optimized to increase the absorption and wet contact area between neighboring particles.
2. Completely change out the used litter because decreased urine penetration decreases the occurrence of litter sticking to the box. Urine penetration can be decreased by controlling the granule size and/or shape to eliminate void space that can serve as channels for urine flow in the litter box.
3. Reduce odor permeability. The same mechanism that inhibits liquid penetration into the box also inhibits vapor penetration out of the box.
4. Avoid litter being tracked out of the litter box because the shape can be optimized to minimize litter sticking to the cat's paws.
5. Absorb spills from a flat surface, e.g., oil on a floor. Flat sides allow particles to lie flat against the surface, maximizing the surface area in contact with the spill.

Several additional uses for the shaped particles are also anticipated, and accordingly the various aspects of the invention are not to be limited to animal litter. For example, interlocking particles may be used as a soil amendment to reduce erosion.

### EXAMPLES

### Example 1

Referring again to FIG. 1, a method for making particles 102 is generally performed using a pan agglomeration process in which clay particles of ≦200 mesh (≦74 microns), preferably ≦325 mesh (≦43 microns) particle size premixed with particles of active, are agglomerated in the presence of an aqueous solution to form particles in the size range of about 12×40 mesh (about 1650-250 microns). Alternatively, the particles are first formed with clay alone, then reintroduced into the pan or tumbler, and the active is added to the pan or tumbler, and a batch run is performed in the presence of water or a binder to adhere the active to the surface of the particles. Alternatively, the active can be sprayed onto the particles.

### Example 2

A method for making particles 104 is generally performed using the process described with relation to FIG. 2, except no core material is added.

### Example 3

A method for making particles 106 is generally performed using the process described with relation to FIG. 2, except that introduction of the absorbent granules and the active into the agglomerator are alternated to form layers of each.

### Example 4

A method for making particles 108 is generally performed using the process described with relation to FIG. 2, except that the active has been pre-clumped using a binder, and the clumps of active are added. Alternatively, particles of absorbent material can be created by agglomeration and spotted with a binder such that upon tumbling with an active, the active sticks to the spots of binder thereby forming concentrated areas. Yet another alternative includes the process of pressing clumps of active into the absorptive material.

### Example 5

A method for making particles 110 is generally performed using the process described with relation to FIG. 2.

### Example 6

A method for making particles 112 is generally performed using the process described with relation to FIG. 2.

### Example 7 & 8

A method for making particles 114 and 116 are generally performed using the process described with relation to FIG. 2, except no active is added.

In addition, the performance-enhancing active can be physically dispersed along pores of the particle by suspending an insoluble active in a slurry and spraying the slurry onto the particles. The suspension travels into the pores and discontinuities, depositing the active therein.

Control Over Particle Properties

Strategically controlling process and formulation variables along with agglomerate particle size distribution allows for the development of various composite particles engineered specifically to enable attribute improvements as needed. Pan agglomeration process variables include but are not limited to raw material and ingredient delivery methods, solid to process water mass ratio, pan speed, pan angle, scraper type and configuration, pan dimensions, throughput, and equipment selection. Formulation variables include but are not limited to raw material specifications, raw material or ingredient selection (actives, binders, clays and other solids media, and liquids), formulation of liquid solution used by the agglomeration process, and levels of these ingredients.

The pan agglomeration process intrinsically produces agglomerates with a narrow particle size distribution (PSD). The PSD of the agglomerates can be broadened by utilizing a pan agglomerator that continuously changes angle (pivots back and forth) during the agglomeration process. For instance, during the process, the pan could continuously switch from one angle, to a shallower angle, and back to the initial angle or from one angle, to a steeper angle, and back to the initial angle. This variable angle process would then repeat in a continuous fashion. The angles and rate at which the pan continuously varies can be specified to meet the operator's desired PSD and other desired attributes of the agglomerates.

As mentioned above, the agglomeration process can be manipulated to control process and formulation variables. This manipulation can be used, for example, to increase or decrease pore size, pore volume and surface area which can then result in control of bulk properties such as the bulk density of the particles (with or without use of core material),the overall liquid absorption capacity by the particles, and the rate of degradation of formed granules under swelling conditions. The pore size, pore volume, surface area and resulting bulk properties depend primarily on the pan angle and the pan speed, which together create an effective pressure on the particles being agglomerated into composite particles. By increasing the pan speed, the centrifugal force exerted on the particles is increased, thereby reducing the internal pore size of the resulting composite particles. Similarly, as the pan angle is increased from the horizontal, the particles will tumble more violently towards the bottom of the pan, again reducing the internal pore size of the resulting composite particles.

A larger pore size results in a lower overall bulk density of the composite particles. A larger pore size also allows odoriferous molecules to more readily reach actives embedded within the composite particles. The pore size also affects hydraulic conductivity.

By knowledge of interactions between pan, dryer, and formulation parameters one could further optimize process control or formulation/processing cost. For example, it was noted that by addition of a minor content of a less absorptive clay, we enabled easier process control of particle size. For example, by addition of calcium bentonite clay the process became much less sensitive to process upsets and maintains consistent yields in particle size throughout normal moisture variation. Addition of calcium bentonite clay also helped reduce particle size even when higher moisture levels were used to improve granule strength. This is of clear benefit as one looks at enhancing yields and having greater control over particle size minimizing need for costly control equipment or monitoring tools.

For those practicing the invention, pan agglomeration manipulation and scale-up can be achieved through an empirical relationship describing the particle's path in the pan. Process factors that impact the path the particle travels in the pan include but are not limited to pan dimensions, pan speed, pan angle, input feed rate, solids to process liquid mass ratio, spray pattern of process liquid spray, position of scrapers, properties of solids being processed, and equipment selection. Additional factors that may be considered when using pan agglomerators include particle to particle interactions in the pan, gravity effects, and the following properties of the particles in the pan: distance traveled, shape of the path traveled, momentum, rotational spin about axis, shape, surface properties, and heat and mass transfer properties.

The composite particles provide meaningful benefits, particularly when used as a cat litter, that include but are not limited to improvements in final product attributes such as odor control, litter box maintenance benefits, reduced dusting or sifting, and consumer convenience. As such, the following paragraphs shall discuss the composite absorbent particles in the context of animal litter, it being understood that the concepts described therein apply to all embodiments of the absorbent particles.

Significant odor control improvements over current commercial litter formulas have been identified for, but are not limited to, the following areas:

Fecal odor control (malodor source: feline feces)

Ammonia odor control (malodor source: feline urine)

Non-ammonia odor control (malodor source: feline urine)

Odor control actives that can be utilized to achieve these benefits include but are not limited to powdered activated carbon, silica powder (Type C), borax pentahydrate, and bentonite powder. The odor control actives are preferably distributed within and throughout the agglomerates by preblending the actives in a batch mixer with clay bases and other media prior to the agglomeration step. The pan agglomeration process, in conjunction with other unit operations described here, allows for the targeted delivery of actives within and throughout the agglomerate, in the outer volume of the agglomerate with a rigid core, on the exterior of the agglomerate, etc. These or any targeted active delivery options could also be performed in the pan agglomeration process exclusively through novel approaches that include, but should not be limited to, strategic feed and water spray locations, time delayed feeders and spray systems, raw material selection and their corresponding levels in the product's formula (actives, binders, clays, and other medium), and critical pan agglomeration process variables described herein.

Additionally, the pan agglomeration process allows for the incorporation of actives inside each agglomerate or granule by methods including but not limited to dissolving, dispersing, or suspending the active in the liquid solution used in the agglomeration process. As the pan agglomeration process builds the granules from the inside out, the actives in the process's liquid solution become encapsulated inside each and every granule. This approach delivers benefits that include but should not be limited to reduced or eliminated segregation of actives from base during shipping or handling (versus current processes that simply dry tumble blend solid actives with solid clays and medium), reduced variability in product performance due to less segregation of actives, more uniform active dispersion across final product, improved active performance, and more efficient use of actives. This more effective use of actives reduces the concentration of active required for the active to be effective, which in turn allows addition of costly ingredients that would have been impractical under prior methods. For example, dye or pigment can be added to vary the color of the litter, lighten the color of the litter, etc. Disinfectant can also be added to kill germs. For example, this novel approach can be utilized by dissolving borax pentahydrate in water. This allows the urease inhibitor (boron) to be located within each granule to provide ammonia odor control and other benefits described here. One can strategically select the proper actives and their concentrations in the liquid solution used in the process to control the final amount of active available in each granule of the product or in the product on a bulk basis to deliver the benefits desired.

Targeted active delivery methods should not be limited to the targeted active delivery options described here or to odor control actives exclusively. For example, another class of active that could utilize this technology is animal health indicating actives such as a pH indicator that changes color when urinated upon, thereby indicating a health issue with the animal. This technology should not be limited to cat litter applications. Other potential industrial applications of this technology include but should not be limited to laundry, home care, water filtration, fertilizer, iron ore pelletizing, pharmaceutical, agriculture, waste and landfill remediation, and insecticide applications. Such applications can utilize the aforementioned unit operations like pan agglomeration and the novel process technologies described here to deliver smart time-releasing actives or other types of actives and ingredients in a strategic manner. The targeted active delivery approach delivers benefits that include but should not be limited to the cost efficient use of actives, improvements in active performance, timely activation of actives where needed, and improvements in the consumer perceivable color of the active in the final product. One can strategically choose combinations of ingredients and targeted active delivery methods to maximize the performance of actives in final products such as those described here.

Litter box maintenance improvements can be attributed to proper control of the product's physical characteristics such as bulk density, clump strength, attrition or durability (granule strength), clump height (reduction in clump height has been found to correlate to reduced sticking of litter to the bottom of litter box), airborne and visual dust, lightweight, absorption (higher absorption correlates to less sticking to litter box—bottom, sides, and corners), adsorption, ease of scooping, ease of carrying and handling product, and similar attributes. Strategically controlling process and formulation variables along with agglomerate particle size distribution allows for the development of various cat litter particles engineered specifically to “dial in” attribute improvements as needed. Pan agglomeration process variables include but are not limited to raw material and ingredient delivery methods, solid to process water mass ratio, pan speed, pan angle, scraper type and configuration, pan dimensions, throughput, and equipment selection. Formulation variables include but are not limited to raw material specifications, raw material or ingredient selection (actives, binders, clays and other solids medium, and liquids), formulation of liquid solution used by the agglomeration process, and levels of these ingredients. For example, calcium bentonite can be added to reduce sticking to the box.

Improvements in consumer convenience attributes include but are not limited to those described here and have been linked to physical characteristics of the product such as bulk density or light weight. Because the absorbent particles are made from small granules, the pan agglomeration process creates agglomerated particles having a porous structure that causes the bulk density of the agglomerates to be lower than its initial particulate form. Further, by adjusting the rotation speed of the pan, porosity can be adjusted. In particular, a faster pan rotation speed reduces the porosity by compressing the particles. Since consumers use products like cat litter on a volume basis, the pan agglomeration process allows the manufacturer to deliver bentonite based cat litters at lower package weights but with equivalent volumes to current commercial litters that use heavier clays that are simply mined, dried, and sized. The agglomerates' reduced bulk density also contributes to business improvements previously described such as cost savings, improved logistics, raw material conservation, and other efficiencies. Lightweight benefits can also be enhanced by incorporating cores that are lightweight. A preferred bulk density of a lightweight litter according to the present invention is less than about 1.5 grams per cubic centimeter and more preferably less than about 0.85 g/cc. Even more preferably, the bulk density of a lightweight litter according to the present invention is between about 0.25 and 0.85 g/cc, and ideally for an animal litter 0.35 and 0.50 g/cc.

The porous structure of the particles also provides other benefits. The voids and pores in the particle allow access to active positioned towards the center of the particle. This increased availability of active significantly reduces the amount of active required to be effective. For example, in particles in which carbon is incorporated in layers or heterogeneously throughout the particle, the porous structure of the absorbent particles makes the carbon in the center of the particle available to control odors. Many odors are typically in the gas phase, so odorous molecules will travel into the pores, where they are adsorbed onto the carbon. By mixing carbon throughout the particles, the odor-absorbing life of the particles is also increased. This is due to the fact that the agglomeration process allows the manufacturer to control the porosity of particle, making active towards the center of the particle available.

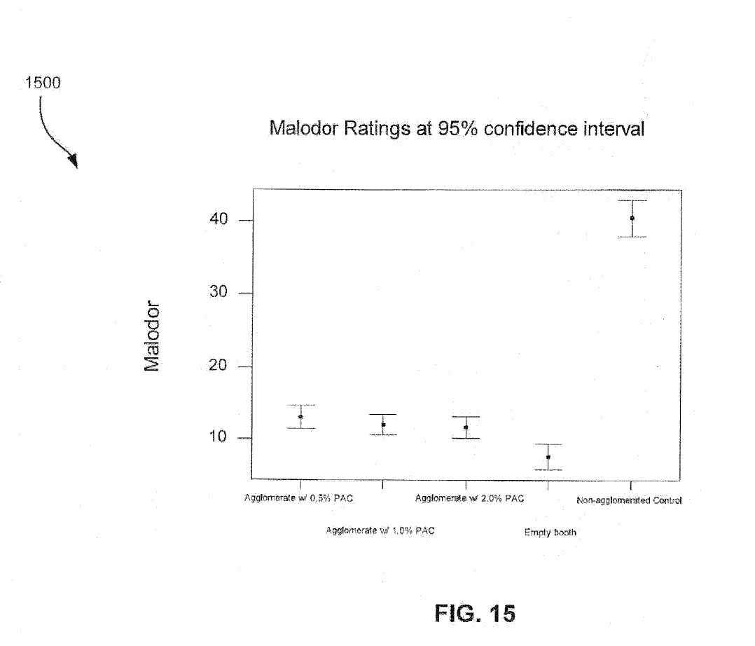

Because of the unique processing of the absorbent particles of the present invention, substantially every absorbent particle contains carbon. As discussed above, other methods merely mix GAC with clay, and compress the mixture into particles, resulting in aggregation and some particles without any carbon. Thus, more carbon must be added. Again, because of the way the particles are formed and the materials used (small clay granules and PAC), lower levels of carbon are required to effectively control odors. In general, the carbon is present in the amount of 5% or less based on the weight of the particle. In illustrative embodiments, the carbon is present in the amount of 1.0% or less, 0.5% or less, and 0.3% or less, based on the weight of the particle. In other embodiments, activated alumina is present in the amount of 1.0% or less, 0.5% or less, and 0.3% or less, based on the weight of the particle. This lower amount of carbon or other odor controlling additive significantly lowers the cost for the particles, as these additives are very expensive compared to clay. The amount of carbon or other odor controlling additive required to be effective is further reduced because the agglomeration process incorporates the carbon into each particle, using it more effectively. As shown in the graph 1500 of FIG. 15, the composite absorbent particles according to a preferred embodiment have a malodor rating below about 15, whereas the non-agglomerated control has a rating of about 40, as determined by a Malodor Sensory Method.

Description of Malodor Sensory Method:
1. Cat boxes are filled with 2,500 cc of test litter.
2. Boxes are dosed each morning for four days with 30 g of pooled feces.
3. On the fourth day the center of each box is dosed with 20 ml pooled urine.
4. The boxes are placed into sensory evaluation booths.
5. The boxes are allowed to equilibrate in the closed booths for 30-45 minutes before panelist evaluation.
6. The samples are then rated on a 60 point line scale by trained panelists.

Preferably, the agglomerated particles exhibit noticeably less odor after four days from contamination with animal waste as compared to a generally solid particle of the absorbent material alone under substantially similar conditions.

As mentioned above, the human objection to odor is not the only reason that it is desirable to reduce odors. Studies have shown that cats prefer litter with little or no smell. One theory is that cats like to mark their territory by urinating. When cats return to the litterbox and don't sense their odor, they will try to mark their territory again. The net effect is that cats return to use the litter box more often if the odor of their markings is reduced.

Accordingly, the composite particles induce a cat to use the litter, and thus provide a mechanism to defeat a cat's instinct to mark its territory in areas other than the litter box.

A preferred embodiment of the present invention has a feline inducement to use index of at least 8, and ideally at least 9, as measured by the following test.

Description of Feline Inducement to Use Index Test:
1. Cat boxes are filled with 2,500 cc of test litter of >95% bentonite, ˜1% activated carbon, and may include other optional actives. The cat boxes are each placed in an individual cage having a floor area of 12 square feet.
2. One cat is placed in each cage and kept there for seven days. The excrement and urine are not removed from the litter.
3. On the seventh day the cage is examined for urine and excrement in areas other than the box.
4. The number of soiled areas of the cage other than the box are enumerated and subtracted from a base number of 10 to produce individual indices. The individual indices are averaged by the total number of cat boxes in the test to determine the feline inducement to use index.

Additionally, in households with multiple cats, one or both cats may object to sharing the litterbox upon sensing the odor of the other cat's waste. However, the superior odor control properties of the composite particles described herein have been found to sufficiently control odors that multiple cats use litter even after an extended period of time.

A preferred embodiment of the present invention has a multiple cat usage index of at least 8, and ideally at least 9, as measured by the following test.

Description of Multiple Cat Usage Index Test:
1. Cat boxes are filled with 2,500 cc of test litter of >95% bentonite, ˜1% activated carbon, ˜1% of a boron compound sprayed onto the particles, and optionally additional actives. The cat boxes are each placed in an individual cage having a floor area of 12 square feet.
2. Two cats are placed in each cage and kept there for seven days. The excrement and urine are not removed from the litter.
3. On the seventh day the cage is examined for urine and excrement in areas other than the box.
4. The number of soiled areas of the cage other than the box are enumerated and subtracted from a base number of 10 to produce individual indices. The individual indices are averaged by the total number of cat boxes in the test to determine the multiple cat usage index.

The composite absorbent particles of the present invention exhibit surprising additional features heretofore unknown. The agglomerated composite particles allow specific engineering of the particle size distribution and density, and thereby the clump aspect ratio. Thus, hydraulic conductivity (K) values of ≦0.25 cm/s as measured by the following method can be predicted using the technology disclosed herein, resulting in a litter that prevents seepage of urine to the bottom of the box when sufficient litter is present in the box.

Method for measuring Hydraulic Conductivity

Materials:
1. Water-tight gas drying tube with 7.5 centimeter diameter
2. Manometer
3. Stop watch
4. 250 ml graduated cylinder

Procedure:
1. Mix and weigh sample
2. Pour the sample into the Drying tube until the total height of the sample is 14.6 centimeters.
3. Close the cell.
4. Use vacuum to pull air through and dry the sample for at least 3 minutes.
5. When the sample is dry, saturate the sample slowly with water by opening the inlet valve.
6. Allow the water exiting the drying tube to fill the graduated cylinder.
7. Deair the system using vacuum, allowing the system to stabilize for 10 minutes.
8. After 10 minutes, record the differential pressure as displayed by the manometer.
9. Record at least 4 differential pressure measurements, waiting 3 minutes between each measurement.
10. Record the flow rate of the water entering the graduated cylinder.
11. Calculate the Hydraulic Conductivity, K, using Darcy's Law
   Q=−KA(ha−hb)/L
   Q=Flow Rate
   K=Hydraulic Conductivity
   A=Cross Sectional Area
   L=Bed Length
   Ha−Hb=Differential Pressure

One of the distinguishing characteristics of the optimum K value is a litter clump with a very low height to length ratio (flat). By controlling the particle size of the litter, clump strength and clump profile can be controlled. This is important because the smaller the clumps are, the less likely they are to stick to something like the animal or litterbox. For instance, with prior art compacted litter, if a cat urinates 1 inch from the side of the box, the urine will penetrate to the side of box and the clay will stick to the box. However, the present invention allows the litter particles to be engineered so urine only penetrates about ½ inch into a mass of the particles.

Agglomerated composite particles according to the present invention also exhibit interesting clumping action not previously seen in the literature. Particularly, the particles exhibit extraordinary clump strength with less sticking to the box, especially in composite particles containing bentonite and PAC. PAC is believed to act as a release agent to reduce sticking to the box. However, intuitively this should also lead to reduced clump strength, not increased clump strength. The combination of stronger clumps yet exhibiting less sticking to the box is both surprising and counter-intuitive. The result is a litter with multiple consumer benefits including strong clumps, low urine seepage, and little sticking to the box.

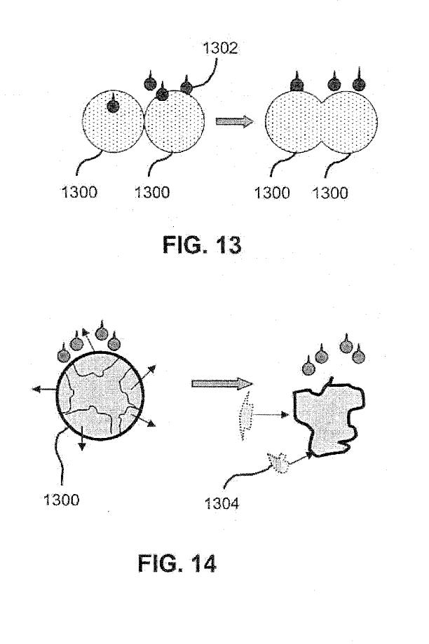

While not wishing to be bound by any particular theory, the increased clump strength is believed to be due to at least some of the PAC-containing granules “falling apart” and releasing their bentonite particles to reorder themselves, and this ‘reordering’ produces a stronger clump. As shown in FIGS. 13 and 14, this can best be described as a disintegration of more-water-soluble pieces of the agglomerated composite particles 1300 when in contact with moisture 1302, allowing the pieces 1304 of the particles to attach to surrounding particles. This “reordering” produces a stronger clump. In testing, the visual appearance of the cores is a signal that at least some of the granules decompose to smaller particles, and these particles are “suspending” in the urine and are free to occupy interstitial spaces between particles, forming a stronger clump. This creates a network of softened agglomerated particles where broken particle pieces are attaching to others and creating a web of clumped material. Note however that the particles described herein should not be limited to clumping or scoopable particles.

As mentioned above, the composite absorbent particles have particular application for use as an animal litter. The litter would then be added to a receptacle (e.g., litterbox) with a closed bottom, a plurality of interconnected generally upright side walls forming an open top and defining an inside surface. However, the particles should not be limited to pet litters, but rather could be applied to a number of other applications such as:
Litter Additives—Formulated product can be pre-blended with standard clumping or non-clumping clays to create a less expensive product with some of the benefits described herein. A post-additive product could also be sprinkled over or as an amendment to the litter box.
Filters—Air or water filters could be improved by either optimizing the position of actives into areas of likely contact, such as the outer perimeter of a filter particle. Composite particles with each subcomponent adding a benefit could also be used to create multi-functional composites that work to eliminate a wider range of contaminants.
Bioremediation/Hazardous/Spill Cleanup—Absorbents with actives specifically chosen to attack a particular waste material could be engineered using the technology described herein. Exemplary waste materials include toxic waste, organic waste, hazardous waste, and non-toxic waste.
Pharma/Ag—Medications, skin patches, fertilizers, herbicides, insecticides, all typically use carriers blended with actives. Utilization of the technology described herein reduce the amount of active used (and the cost) while increasing efficacy.
Soaps, Detergents, and other Dry Products—Most dry household products could be engineered to be lighter, stronger, longer lasting, or cheaper using the technology as discussed above.
Mixtures of Different Particles—The composite particles can be dry mixed with other types of particles, including but not limited to other types of composite particles, extruded particles, particles formed by crushing a source material, etc. Mixing composite particles with other types of particles provides the benefits provided by the composite particles while allowing use of lower cost materials, such as crushed or extruded bentonite. Illustrative ratios of composite particles to other particles can be 75/25, 50/50, 25/75, or any other ratio desired. For example, in an animal litter created by mixing composite particles with extruded bentonite, a ratio of 50/50 will provide enhanced odor control, clumping and reduced sticking, while reducing the weight of the litter and lowering the overall cost of manufacturing the litter.
Mixtures of Composite Particles with Actives—The composite particles can be dry mixed with actives, including but not limited to particles of activated carbon.

### Additional Examples

Note that all percentages are in weight percent in the following examples.

### Example 9

A composite particle includes:
about 90-99.5% sodium bentonite as the primary absorbent material
about 0.1-10% activated carbon added to the sodium bentonite as in particles 102-108 and 114 of FIG. 1
about 0-9.9% additional active

### Example 10

A composite particle includes:
about 90-99.5% sodium bentonite as the primary absorbent material
about 0.1-10% zeolite, crystalline silica, silica gel, activated alumina, activated carbon, a superabsorbent polymer, and mixtures thereof added to the sodium bentonite as in particles 102-108 and 114 of FIG. 1
about 0-9.9% additional active

### Example 11

A composite particle includes:
about 10-70% core material selected from zeolite, crystalline silica, silica gel, activated alumina, activated carbon, a superabsorbent polymer, and mixtures thereof
about 30-90% sodium bentonite surrounding the core
about 0.1-10% activated carbon added to the sodium bentonite as in particles 110-112 and 116 of FIG. 1
about 0-10% additional active

### Example 12

A composite particle includes:
about 10-70% core material selected from zeolite, crystalline silica, silica gel, activated alumina, activated carbon, a superabsorbent polymer, and mixtures thereof
about 30-90% sodium bentonite surrounding the core
about 0.1-25% zeolite, crystalline silica, silica gel, activated alumina, a superabsorbent polymer, and mixtures thereof added to the sodium bentonite as in particles 110-112 and 116 of FIG. 1
about 0-10% additional active

### Example 13

A composite particle includes:
about 10-70% core formed from agglomerated particles
about 30-90% sodium bentonite surrounding the core
about 0.1-25% zeolite, crystalline silica, silica gel, activated alumina, a superabsorbent polymer, and mixtures thereof added to the sodium bentonite as in particles 110-112 and 116 of FIG. 1
about 0-10% additional active

### Example 14

An absorbent composition of multiple composite particles, each composite particle including:
optional 10-70% core
about 30-100% agglomerated absorbent material
about 0.1-10% active added to the absorbent material as in particles 102-116 of FIG. 1
about 0-10% additional active selected from an antimicrobial, an odor reducing material, a binder, a fragrance, a health indicating material, a color altering agent, a dust reducing agent, a nonstick release agent, a superabsorbent material, cyclodextrin, zeolite, activated carbon, a pH altering agent, a salt forming material, a ricinoleate, silica gel, crystalline silica, and mixtures thereof
where about 1-25% of the composite particles are colored for creating “speckles” in the litter

### Example 15

An absorbent composition of multiple composite particles admixed with particles of sodium bentonite, including:
about 10-90% particles of swellable sodium bentonite clay particles, ˜1.4 mm-0.3 mm (14×50 mesh), dried and crushed
about 10-90% composite particles, each composite particle including:
   optional 10-70% core
   about 30-100% agglomerated absorbent material
   about 0.1-10% active added to the absorbent material as in particles 102-116 of FIG. 1
   about 0-10% additional active selected from an antimicrobial, an odor reducing material, a binder, a fragrance, a health indicating material, a color altering agent, a dust reducing agent, a nonstick release agent, a superabsorbent material, cyclodextrin, zeolite, activated carbon, a pH altering agent, a salt forming material, a ricinoleate, silica gel, crystalline silica, and mixtures thereof
about 0-25% colored or white “speckles” in the litter (can be activated alumina, colored composite particles, etc.)

The activated alumina itself may include an embedded coloring agent that has been added during the fabrication of the activated alumina particles. The inventors have found that the odor absorbing properties of activated alumina are not significantly reduced due to the application of color altering agents thereto.

Additionally, activated alumina's natural white coloring makes it a desirable choice as a white, painted or dyed “speckle” in litters. In composite and other particles, the activated alumina can also be added in an amount sufficient to lighten or otherwise alter the overall color of the particle or the overall color of the entire composition.

Compositions may also contain visible but ineffective colored speckles for visual appeal. Examples of speckle material are salt crystals or gypsum crystals.

### Example 16

An absorbent composition of multiple composite particles admixed with particles of sodium bentonite, including:
about 10-90% composite particles, each composite particle including:
   optional 10-70% core
   about 30-99.9% agglomerated absorbent material
   about 0.1-10% active added to the absorbent material as in particles 102-116 of FIG. 1
   about 0-10% additional active selected from an antimicrobial, an odor reducing material, a binder, a fragrance, a health indicating material, a color altering agent, a dust reducing agent, a nonstick release agent, a superabsorbent material, cyclodextrin, zeolite, activated carbon, a pH altering agent, a salt forming material, a ricinoleate, silica gel, crystalline silica, and mixtures thereof
about 0.01-50% particles of activated alumina dry mixed with the composite particles. Preferably, the activated alumina is present in the composition in an amount of about 0.01% to about 50% of the composition by weight based on the total weight of the absorbent composition. More preferably, the activated alumina is present in the composition in an amount of about 0.1% to about 25% by weight.

### Example 17

An absorbent composition (clumpable or nonclumpable) with improved odor control includes:
about 0.1-25.0% activated alumina and/or zeolite and/or silica particles
about 0-75% additives
to 100% composite particles as in particles 102-116 of FIG. 1

### Example 18

An absorbent composition with antimicrobial benefit includes:
about 0.5-5.0% activated alumina and/or zeolite and/or silica particles [odor control]
about 0.001-1.0% borax pentahydrate [antimicrobial]
about 0.001-10% fragrance
about 0-25% additional additives
to 100% composite particles as in particles 102-116 of FIG. 1

### Example 19

A clumping absorbent composition with antimicrobial benefit includes:
about 2% colored activated alumina and/or zeolite and/or silica particles, 1-2 mm (10×18 mesh)
about 0.5% borax pentahydrate [antimicrobial]
about 0.71% spray-dried fragrance—sprayed onto starch beads and mixed in
about 96.79% composite particles as in particles 102-116 of FIG. 1, ˜1.4 mm-0.3 mm (14×50 mesh), dried and crushed

### Example 20

The following composition provides the benefit of improved odor control throughout the litter due to the varying densities of zeolite, activated, alumina, and silica gel.

An absorbent composition that is either clumpable or nonclumpable includes:
about 0.001-25.0% zeolite particles
about 0.001-25.0% activated alumina particles
about 0.001-25.0% silica gel particles
about 0-50% additives
to 100% composite particles including sodium bentonite clay as in particles 102-116 of FIG. 1

The zeolite is the heaviest of the three odor-absorbing materials, alumina is in the middle, and silica gel is the lightest. Because of the tendency of the materials to segregate upon agitation such as a cat digging in the litterbox, the zeolite, being heavier, will tend to move towards the bottom of the litter, while the lighter silica gel will tend to migrate towards the top of the litter. Thus, the litter will contain odor controlling actives throughout. An additional benefit is that the silica gel tends to repel liquid running across it, making it the ideal material for the upper layer of litter, as it will not immediately become saturated by animal urine but will retain its odor absorbing properties.

Also, by adding a lighter material such silica (25 lbs/ft³) or zeolite (about 50 lbs/ft³), the overall weight per volume unit of the mixture is reduced.

For clumping litter not relying on binders for clump strength, the total content of zeolite, activated alumina, and silica gel particles is preferably less than about 25% so that the clay provides satisfactory clumping performance.

### Example 21

In a variation of Example 20:

An absorbent composition that is either clumpable or nonclumpable includes:
about 0.001-25.0% activated alumina particles
about 0.001-25.0% zeolite particles
about 0-50% additives
to 100% composite particles as in particles 102-116 of FIG. 1

### Example 22

In a variation of Example 20:

An absorbent composition that is either clumpable or nonclumpable includes:
about 0.001-25.0% zeolite particles
about 0.001-25.0% silica gel particles
about 0-50% additives
to 100% composite particles as in particles 102-116 of FIG. 1

### Example 23

In a variation of Example 20:

An absorbent composition that is either clumpable or nonclumpable includes:
about 0.001-25.0% activated alumina particles
about 0.001-25.0% silica gel particles
about 0-50% additives
to 100% composite particles as in particles 102-116 of FIG. 1

### Example 24

A flushable and clumping absorbent composition with improved odor control includes:
about 0.1-25.0% activated alumina and/or zeolite and/or silica particles
about 0-75% additives
less than about 1% of a water soluble binding agent
to 100% composite particles as in particles 102-116 of FIG. 1

### Example 25

A clumping absorbent composition with liquid retention and smaller clump aspect ratio includes:
about 90-99.5% sodium bentonite having a mean particle size in the
range of about −100 to +200 mesh
about 0.5-10% SAP
about 0-75% additives
to 100% composite particles as in particles 102-116 of FIG. 1

### Example 26

### Experimental Data of Composite Particles with SAP

In one set of experiments aimed at studying the surface stiffness and clump characteristics of blends of SAP with sodium bentonite clay, SAP agglomerated with sodium bentonite was compared to pure agglomerated sodium bentonite and raw bentonite (not agglomerated).

During the procedure, synthetic urine (10 ml of 1M NH₄Cl) as liquid was added to the agglomerate containing SAP (2% Hysorb 8400 SAP from BASF Corporation, 98% sodium bentonite), agglomerated sodium bentonite, and plain bentonite. In more detail, the procedure was as follows: 1) add 10 m ml NH₄CL to the litter and wait 30 seconds, 2) tarc a 9 inch diam. circle of Whitman No. 1 filter paper and drop the paper onto the wetted litter, 3) allow the filter paper to sit on the litter for 30 seconds, then remove and weigh to calculate the amount of material transferred to the filter paper (stickiness), and 4) after 1 hour of setting time, measure the clump mass, clump depth, and calculate absorption as (mass liquid)/[(clump mass−mass liquid)].

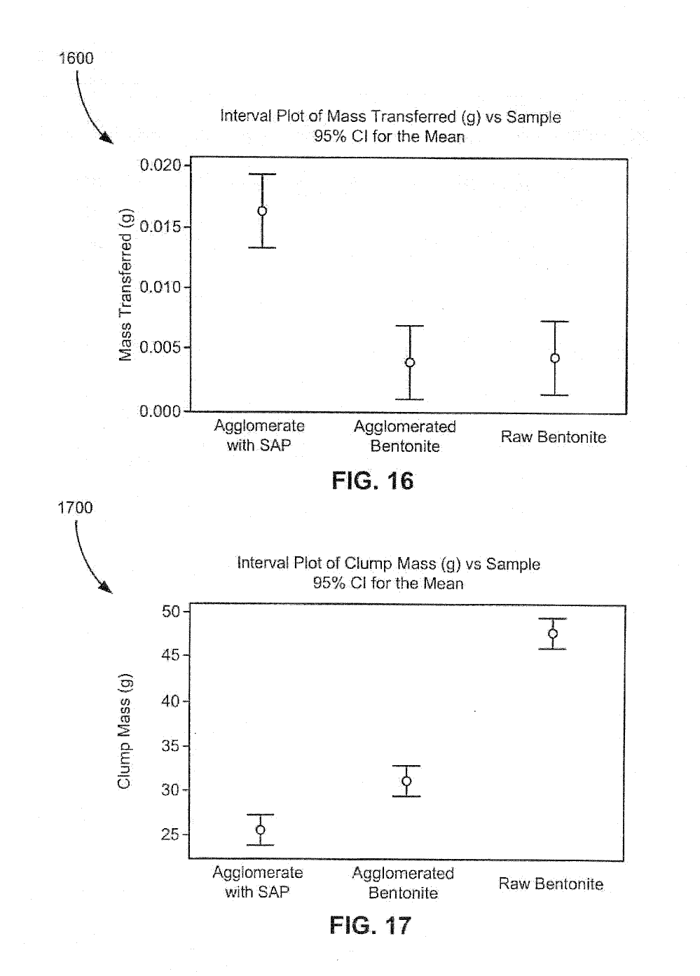

FIG. 16 illustrates an interval plot 1600 of mass transferred (g) to the dropped filter paper vs. sample (surface stickiness). As shown, the sample with SAP clearly had more surface stickiness. The surface stickiness improves clump strength. Note that the SAP in the agglomerated particles had a smaller particle size than the agglomerate alone. Accordingly, some of the stickiness could be attributable to the smaller particulate size, as well as the SAP.

FIG. 17 illustrates an interval plot 1700 of clump mass (g) vs. sample. As shown, the clump mass of the SAP-containing particles was much less than raw bentonite or the agglomerated bentonite. This is believed to reflect less material in the clump, as well as lighter overall particles.

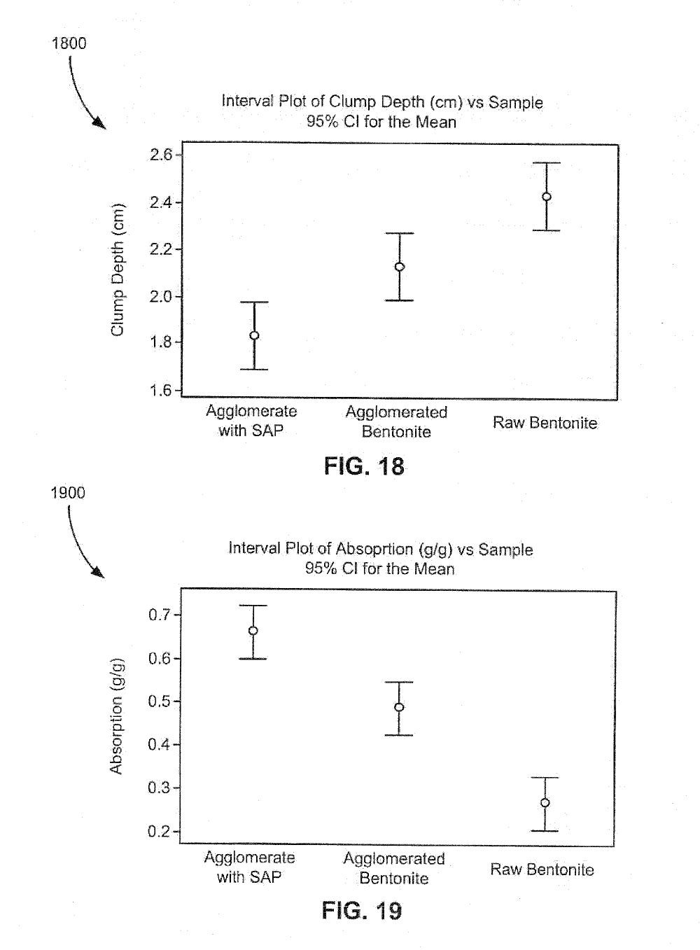

FIG. 18 illustrates an interval plot 1800 of clump depth (cm) vs. sample. As shown, both agglomerates inhibit penetration, but the SAP-containing particle showed greater inhibition.

FIG. 19 illustrates an interval plot 1900 of liquid absorption (g/g) vs. sample as calculated by the formula above. As shown, the agglomerated bentonite sample absorbed about twice as much liquid as the plain bentonite sample, while the SAP-containing particle absorbed about three times as much liquid as the plain bentonite sample.

### Example 27

In a variation of particles from any example above, and/or formed of a single material:

An absorbent composition that is either clumpable or nonclumpable includes:
about 5-95% first absorbent particles as in particles 1000-1034 of FIG. 10, and
about 5-95% second absorbent particles as in particles 1000-1034 of FIG. 10, but having a different shape than the first absorbent particles.

### Example 28

In a variation of Example 27:

An absorbent composition that is either clumpable or nonclumpable includes:
about 5-95% first absorbent particles as in particles 1000-1034 of FIG. 10, and
about 5-95% second absorbent particles as in particles 1000-1034 of FIG. 10, having about the same shape as, or different shape than, the first absorbent particles but a different bulk density.

### Example 29

In a variation of Example 27:

An absorbent composition that is either clumpable or nonclumpable includes:
about 5-95% first absorbent particles as in particles 1000-1034 of FIG. 10, and
about 5-95% second absorbent particles as in particles 1000-1034 of FIG. 10, having about the same shape as, or different shape than, the first absorbent particles but a different maximum distal dimension (e.g., length, diameter, width, height, etc.).

### Example 30

In a variation of Example 27:

An absorbent composition that is either clumpable or nonclumpable includes:
about 5-95% first absorbent particles as in particles 102-116 of FIG. 1, and
about 5-95% second absorbent particles as in particles 1000-1034 of FIG. 10.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. Composite particles suitable for use as a clumping animal litter, comprising:
a liquid-absorbing absorbent material suitable for use as an animal litter; and
a superabsorbent polymer coupled to the absorbent material, wherein a ratio of rates of absorption of the superabsorbent polymer and absorbent material is at least about 1:1.

2. Composite particles as recited in claim 1, wherein the composite particles tend to clump together in the presence of a liquid

3. Composite particles as recited in claim 1, wherein the absorbent material is sodium bentonite clay.

4. Composite particles as recited in claim 1, further comprising a performance-enhancing active selected from a group consisting of an antimicrobial, an odor reducing material, a binder, a fragrance, a health indicating material, a color altering agent, a dust reducing agent, a nonstick release agent, a superabsorbent material, cyclodextrin, zeolite, activated carbon, a pH altering agent, a salt forming material, a ricinoleate, silica gel, crystalline silica, activated alumina, a clump enhancing agent, a reinforcing fiber material and mixtures thereof.

5. Composite particles as recited in claim 1, further comprising a boron-containing compound.

6. Composite particles as recited in claim 5, wherein the boron-containing compound is present in an antimicrobially effective amount, wherein the boron containing compound is selected from a group consisting of borax pentahydrate, borax decahydrate, boric acid, polyborate, tetraboric acid, sodium metaborate, anhydrous, boron components of polymers, and mixtures thereof.

7. Composite particles as recited in claim 1, wherein a clump of the particles is at least 90% retained according to a clump strength test.

8. Composite particles as recited in claim 1, wherein the superabsorbent polymer has a greater Jenkins osmotic potential than the absorbent material.

9. Composite particles as recited in claim 1, wherein an average particle size of the superabsorbent polymer is smaller than an average particle size of the absorbent material.

10. Composite particles as recited in claim 1, further comprising a humectant coupled to particles of the superabsorbent polymer.

11. Composite particles as recited in claim 1, further comprising a desiccant coupled to particles of the superabsorbent polymer.

12. Composite particles as recited in claim 1, further comprising a deliquescent coupled to particles of the superabsorbent polymer.

13. Composite particles as recited in claim 1, wherein the superabsorbent polymer is substantially homogeneously dispersed throughout at least a portion of the absorbent material.

14. Composite particles as recited in claim 1, wherein the superabsorbent polymer is physically dispersed in pockets in the particle.

15. Composite particles as recited in claim 1, wherein the superabsorbent polymer is physically dispersed in at least one position selected from along surfaces of the particle and contained within pores of the particle.

16. Composite particles as recited in claim 1, wherein the composite particles have been formed by an agglomeration process.

17. Composite particles as recited in claim 1, wherein at least some of the composite particles are hollow.

18. Composite particles as recited in claim 1, wherein at least some of the composite particles naturally form a general bagel shape.

19. Composite particles suitable for use as a clumping animal litter, comprising:
an absorbent material; and
a superabsorbent polymer coupled to the absorbent material, wherein a ratio of rates of absorption of the superabsorbent polymer and absorbent material is at least about 1:1, wherein the composite particles tend to clump together in the presence of a liquid, wherein an average particle size of the superabsorbent polymer is smaller than an average particle size of the absorbent material.

20. Composite particles suitable for use as a clumping animal litter, comprising:
an absorbent material; and
a superabsorbent polymer coupled to the absorbent material, wherein the superabsorbent polymer has a greater Jenkins osmotic potential than the absorbent material.
